(19) United States
(12) Patent Application Publication
(10) Pub. No.: US 2020/0321005 A1
(43) Pub. Date: Oct. 8, 2020

(54) CONTEXT-BASED ENHANCEMENT OF AUDIO CONTENT

(71) Applicant: ADORI LABS, INC., Santa Clara, CA (US)

(72) Inventors: Viswanathan IYER, Santa Clara, CA (US); Kartik PARIJA, Bangalore (IN); Vinod HEGDE, Bangalore (IN)

(21) Appl. No.: 16/840,389

(22) Filed: Apr. 5, 2020

Related U.S. Application Data
(60) Provisional application No. 62/830,177, filed on Apr. 5, 2019.
(60) Provisional application No. 62/954,430, filed on Dec. 28, 2019.

(51) Int. Cl. G10L 15/26; G10L 15/193; G06N 20/00; G06K 9/62

(52) U.S. Cl. CPC G10L 15/26; G10L 15/193; G10L 2015/088; G06K 9/6263; G06N 20/00

(57) ABSTRACT

Some examples include a system configured to present, in a user interface, text of a transcript of audio content. The user interface may further include a timeline representative of at least a portion of the audio content. The system may identify a plurality of keywords in the text, and may determine, based on a first keyword of the plurality of keywords, first data to associate with a time in the timeline in the user interface. In addition, the system may send, to the audio encoder, the first data to cause the audio encoder to embed the first data in the audio content at a timing corresponding to the time in the timeline to generate enhanced audio content.

### CROSS-REFERENCES TO RELATED APPLICATIONS

This application claims the benefit of U.S. Provisional Application No. 62/830,177, filed Apr. 5, 2019, and U.S. Provisional Application No. 62/954,430, filed Dec. 28, 2019, which are incorporated by reference herein.

The following documents are incorporated by reference herein: U.S. Pat. No. 10,277,345 to Iyer et al., U.S. Pat. No. 9,882,664 to Iyer et al.; U.S. Pat. No. 9,484,964 to Iyer et al.; U.S. Pat. No. 8,787,822 to Iyer et al.; U.S. Patent Application Pub. No. 2014/0073236 to V. Iyer.; and US Patent Application Pub. No. 20190122698 to V. Iyer.

### BACKGROUND

Consumers spend a significant amount of time listening to audio content, such as may be provided through a variety of sources, including podcasts, Internet radio stations, streamed audio, downloaded audio, broadcast radio stations, satellite radio, smart speakers, MP3 players, CD players, audio content included in video and other multimedia content, audio from websites, and so forth. Consumers also often desire the option to obtain additional information that may be associated with the subject of the audio content and/or various other types of related entertainment, promotions, and so forth. However, actually providing additional information to listeners at an optimal timing can be challenging.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example system for embedding data in audio content and subsequently extracting data from the audio content according to some implementations.

FIG. 2 illustrates an example of the user interface according to some implementations.

FIG. 3 is a flow diagram illustrating an example process for selecting content to be encoded into main audio content according to some implementations.

FIG. 4 illustrates an example process that may be executed by the electronic device for presenting additional content on the electronic device according to some implementations.

FIG. 5 illustrates an example timeline portion for a main audio content according to some implementations.

FIG. 6 illustrates example first timeline portion and a second timeline according to some implementations.

FIG. 7 illustrates an example user interface for associating keywords with content according to some implementations.

FIG. 8 is a flow diagram illustrating an example process for selecting content to be encoded into main audio content according to some implementations.

FIG. 9 illustrates select components of an example service computing device that may be used to implement some functionality of the services described herein.

FIG. 10 illustrates select example components of an electronic device according to some implementations.

### DETAILED DESCRIPTION

Some examples herein include techniques and arrangements for augmentation of audio content by adding additional interactive content to the audio content. For example, the technology herein may improve on traditional audio content to deliver new experiences and generate unprecedented insights by embedding interactive elements into the audio content without changing the format of the audio content or sacrificing the sound quality of the audio. For instance, some examples herein include the ability to display or otherwise present content-related information along with the audio content, such as by way of visual interaction on a mobile device or other electronic device.

Additionally, some implementations herein provide enhanced audio content by associating visual content and/or additional audio content with the main audio content to create the enhanced audio content. In some implementations, the main audio content may be enhanced based at least in part by using certain extracted keywords to match with a content inventory or various other keyword targets. Selected additional content may be inserted into the main audio content being enhanced. Example techniques for inserting information into audio content, including encoding/decoding methods and systems to achieve this are described in the documents discussed above in the Cross-References to Related Applications section and which have been incorporated herein by reference.

In some examples, the additional data for enhancing the main audio content may include two layers. For instance, a first layer (e.g., an audio layer) may contain audio that when inserted in the audio content attaches to a timeline as a playlist. A second layer (an interactive layer) may include additional content (sometimes referred to as a “content tag” herein) that is associated with the main audio content, which may include one or more visuals and actionable links such as by linking to a uniform resource locator (URL). The additional content (content tag) may be embedded in the audio content without affecting the audio quality of the main audio content. Additionally, or alternatively, one or more links to the additional content may be embedded in the audio content, similarly without affecting the audio quality of the main audio content. In some examples, a timing indicator may be embedded in the main audio content for enabling additional content to be accessed according to a prescribed timing with respect to the main audio content. Thus, some examples may include the ability to add one or more timing indicators within a timeline of the main audio content and to be able to move, delete or replace these timing indicators, thereby creating a subset of additional audio content within the main audio content.

Some implementations may include an encoding program that may be used for embedding additional data in the main audio content. In some cases, the encoding program, may be a web-based software that enables the additional data to be selected using an automated functionality and embedded in the audio content. Examples of additional content that may be embedded in the main audio content may include images, videos, maps, polls, quotes, multimedia, audio content, text, web links and other contextually relevant information that may be presented alongside the main audio content for providing a rich multimedia experience.

Additionally, implementations herein may include a client application that may be installed on an electronic device of a consumer, and that may be configured to decode and present the additional content included in the main audio content. For example, if the content to be presented is embedded in the main audio content, the user application may present the additional content directly according to a specified timing. Alternatively, if the additional content is to be retrieved from a remote computing device based on a link embedded in the main audio content, the user application may be configured to extract the link from the main audio content, retrieve the additional content based on the link, and present the additional content according to a specified timing coordinated with the main audio content.

In addition, in some examples, the client application on the electronic device may generate a transcript of at least a portion of the received main audio content, such as by using natural language processing and speech to text recognition. The client application may spot keywords in the transcript, such as based on a keyword library, or through any of various other techniques. The client application may apply a machine-learning model or other algorithm for selecting one or more keywords to select for fetching additional content for presenting the additional content on the electronic device. For example, the client application may send the selected keyword(s) to a third party computing device configured to provide additional content to the client application based on receiving the keyword(s) from the client application. The client application may receive the additional content from the third party computing device and may present the additional content on the electronic device of the consumer according to a timing determined by the client application based on the transcript. Additionally, in some examples, the client application may request the additional content from the service computing device, rather than from a third party computing device.

Furthermore, some examples herein may include an analytics program that provides a dashboard or other user interface for users to determine information about an audience of the main audio content. For example, the analytics program may determine and provide content analytics, which may include engagement analytics, usage logs, user information and statistics, or the like, for particular main audio content.

Implementations herein enable creators, publishers and other entities the capability to enhance audio content. In addition, consumers of the encoded audio content herein are able to actively engage with additional interactive contextual content both while listening to the main audio content and after listening to the main audio content. For instance, examples herein may provide consumers with one-tap access to relevant links, social feeds, polls, purchase options, and so forth. Furthermore, some examples may employ automatically generated audio transcription to extract keywords, which may be used to automatically identify and insert relevant additional content as a companion to the main audio content.

Some examples include embedding data into audio content at a first location, receiving the audio content at one or more second locations, and obtaining the embedded data from the audio content. In some cases, the embedded data may be extracted from the audio content or otherwise received by an application executing on an electronic device that receives the audio content. The embedded data may be embedded in the audio content for use in an analog audio signal, such as may be transmitted by a radio frequency carrier signal, and/or may be embedded in the audio content for use in a digital audio signal, such as may be transmitted across the Internet or other networks. In some cases, the embedded data may be extracted from sound waves corresponding to the audio content.

The data embedded within the audio signals may be embedded in real time as the audio content is being generated and/or may be embedded in the audio content in advance and stored as recorded audio content having embedded data. Examples of data that may be embedded in the audio signals can include identifying information, such as an individually distinguishable system identifier (ID) (referred to herein as a universal ID) that may be assigned to individual or distinct pieces of audio content, programs or the like. Additional examples of data that can be embedded include a timestamp, location information, and a source ID, such as a station ID, publisher ID, a distributor ID, or the like. In some examples, the embedded data may further include, or may include pointers to, web links, hyperlinks, URLs, third party URLs, or other network location identifiers, as well as photographs or other images, text, bar codes, two-dimensional bar codes (e.g., matrix style bar codes, QR CODES®, etc.), multimedia content, and so forth.

In some implementations, an audio encoder for embedding the data in the audio content may be located at the audio source, such as at a podcast station, an Internet radio station, other Internet streaming location, a radio broadcast station, or the like. The audio encoder may include circuitry configured to embed the additional content in the main audio content in real time at the audio source. The audio encoder may include the capability to embed data in digital audio content and/or analog audio content. In addition, previously embedded data may be detected at the audio source, erased or otherwise removed from the main audio content, and new or otherwise different embedded data may be added to the main audio content to generate enhanced audio content prior to transmitting the enhanced audio content to an audience.

Furthermore, at least some electronic devices of the consumers (e.g., audience members) may execute respective instances of a client application that receives the embedded data and, based on information included in the embedded data, communicates over one or more networks with a service computing device that receives information from the client application regarding or otherwise associated with the information included in the embedded data. For example, the embedded data may be used to access a network location that enables the client application to provide information to the service computing device. The client application may provide information to the service computing device to identify the audio content received by the electronic device, as well as other information, such as that mentioned above, e.g., broadcast station ID, podcast station ID, Internet streaming station ID, or other audio source ID, electronic device location, etc., as additionally described elsewhere herein. Accordingly, the audio content may enable attribution to particular broadcasters, streamers, or other publishers, distributers, or the like, of the audio content.

In some examples, the embedded data may include a call to action that is provided by or otherwise prompted by the embedded data. For instance, the embedded data may include pointers to information (e.g., 32 bits per pointer) to enable the client application to receive additional content from a service computing device, such as a remote web server, a content server, or the like. Further, some embedded data may also include a source ID that identifies the source of the audio content, which the service computing device can use to determine the correct data to serve based on a received pointer. For instance, the client application on each consumer's electronic device may be configured to send information to the service computing device over the Internet or other IP network, such as to identify the audio content or the audio source, identify the client application and/or the electronic device, identify a user account associated with the electronic device, and so forth. Furthermore, the client application can provide information regarding how the audio content is played back or otherwise accessed, e.g., analog, digital, cellphone, car radio, computer, or any of numerous other devices, and how much of the audio content is played or otherwise accessed.

In some examples, the audio source computing device may be able to determine in real time a plurality of electronic devices that are tuned to or otherwise currently accessing the audio content. For example, when the electronic devices of the consumers receive the audio content, the client application on each electronic device may contact a service computing device, such as on a periodic basis, as long as the respective electronic device continues to play or otherwise access the audio content. Thus, the source computing device, in communication with the serviced computing device, is able to determine in real time and at any point in time the reach and extent of the audience of the audio content. Furthermore, because the source computing device has information regarding each electronic device tuned to the audio content, the audio source and/or third party computing devices are able to push additional content to the electronic devices over the Internet or other network. Additionally, because the source computing device may manage both the timing at which the audio content is broadcasted or streamed, and the timing at which the additional content is pushed over the network, the reception of the additional content by the electronic devices may be timed for coinciding with playback of a certain portion of the audio content.

In some examples, the additional content may be represented by JSON (JavaScript Object Notation) code or other suitable programming language. The client application, in response to receiving the JSON code can render an embedded image, open an embedded URL or other http link, such as when a user clicks on it, or in the case of a phone number tag, may display the phone number and enable a phone call to be performed when the user clicks on or otherwise selects the phone number. Further, in some cases, the additional content may include a call to action that may be performed by the consumer, such as clicking on a link, calling a phone number, sending a communication, or the like. Thus, numerous other types of additional content may be dynamically provided to the electronic devices while the audience members are accessing the audio content, such as poll questions, images, videos, social network posts, additional information related to the audio content, a URL, etc.

In addition, after the additional content is communicated to the connected electronic devices of the audience members, the service computing device may receive feedback from the electronic devices, either from the client application or from user interaction with the application, as well as statistics on audience response, etc. For example, the data analytics processes herein may include collection, analysis, and presentation/application of results, which may include feedback, statistics, recommendations and/or other applications of the analysis results. In particular, the data may be received from a large number of client devices along with other information about the audience. For instance, the audience members who use the client application may opt in to providing information such as geographic region in which they are located when listening to the audio content, anonymous demographic information associated with each audience member.

For discussion purposes, some example implementations are described in the environment of automatically selecting and embedding data in audio content. However, implementations herein are not limited to the particular examples provided, and may be extended to other content sources, systems, and configurations, other types of encoding and decoding devices, other types of embedded data, and so forth, as will be apparent to those of skill in the art in light of the disclosure herein.

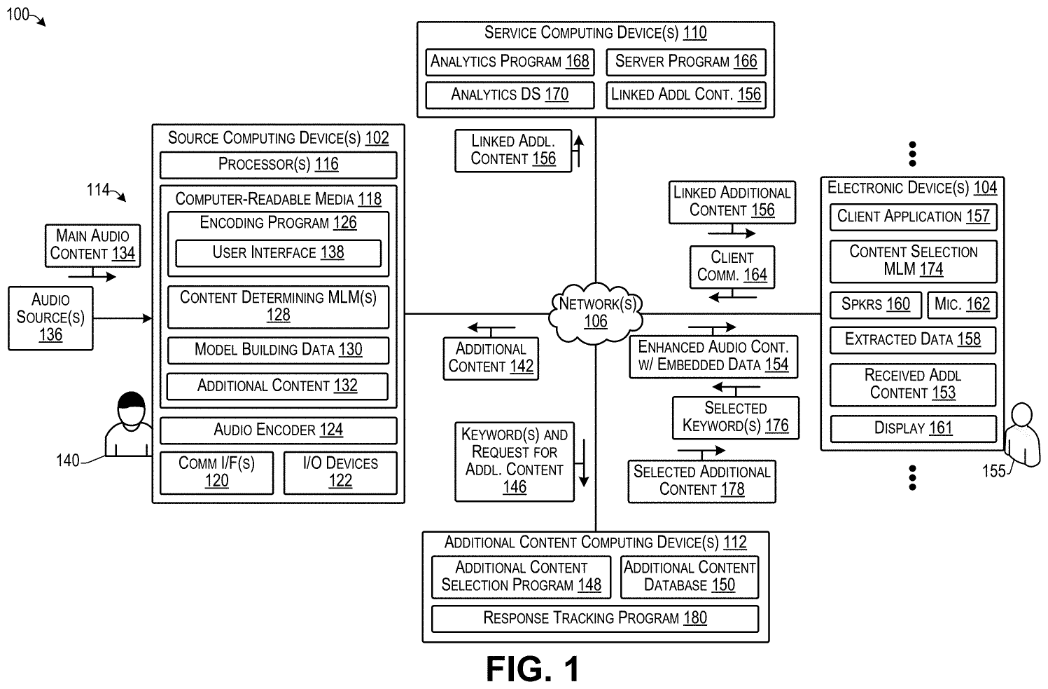

FIG. 1 illustrates an example system 100 for embedding data in audio content and subsequently extracting data from the audio content according to some implementations. In in this example, one or more source computing devices 102 are able to communicate with a plurality of electronic devices 104 over one or more networks 106. In addition, the source computing devices are also able to communicate over the one or more networks 106 with one or more service computing devices 110 and one or more additional content computing devices 112.

In some cases, the source computing device(s) 102 may be associated with an audio source location 114. Examples, of the audio source location 114 may include at least one of an Internet radio station, a podcast station, a streaming media location, a digital download location, a broadcast radio station, a television station, a satellite radio station, and so forth. The source computing device 102 may include or may have associated there with one or more processors 116, one or more computer readable media 118, one or more communication interfaces 120, one or more I/O devices 122, and at least one audio encoder 124.

In some examples, the source computing device(s) 102 may include one or more of servers, personal computers, workstation computers, desktop computers, laptop computers, tablet computers, mobile devices, smart phones, or other types of computing devices, or combinations thereof, that may be embodied in any number of ways. For instance, the programs, other functional components, and data may be implemented on a single computing device, a cluster of computing devices, a server farm or data center, a cloud-hosted computing service, and so forth, although other computer architectures may additionally or alternatively be used.

Further, while the figures illustrate the functional components and data of the source computing device 102 as being present in a single location, these components and data may alternatively be distributed across different computing devices and different locations in any manner. Additionally, in some examples, at least some of the functions of the service computing device(s) 110 and those of the source computing device(s) 102 may be combined in a single computing device, single location, single cluster of computing devices, or the like. Consequently, the functions may be implemented by one or more computing devices, with the various functionality described above distributed in various ways across the one or more computing devices. Multiple source computing devices 102 may be located together or separately, and organized, for example, as virtual machines, server banks, and/or server farms. The described functionality may be provided by the computing device(s) of a single entity or enterprise, or may be provided by the computing devices of multiple different entities or enterprises.

In the illustrated example, each processor 116 may be a single processing unit or a number of processing units, and may include single or multiple computing units or multiple processing cores. The processor(s) 116 can be implemented as one or more microprocessors, microcomputers, microcontrollers, digital signal processors, central processing units, state machines, logic circuitries, and/or any devices that manipulate signals based on operational instructions. For instance, the processor(s) 116 may be one or more hardware processors and/or logic circuits of any suitable type specifically programmed or configured to execute the algorithms and processes described herein. The processor(s) 116 can be configured to fetch and execute computer-readable instructions stored in the computer-readable media 118, which can program the processor(s) 116 to perform the functions described herein.

The computer-readable media 118 may include volatile and nonvolatile memory and/or removable and non-removable media implemented in any type of technology for storage of information, such as computer-readable instructions, data structures, program modules, or other data. Such computer-readable media 118 may include, but is not limited to, RAM, ROM, EEPROM, flash memory or other memory technology, optical storage, solid state storage, magnetic tape, magnetic disk storage, storage arrays, network attached storage, storage area networks, cloud storage, or any other medium that can be used to store the desired information and that can be accessed by a computing device. Depending on the configuration of the source computing device 102, the computer-readable media 118 may be a type of computer-readable storage media and/or may be a tangible non-transitory media to the extent that when mentioned herein, non-transitory computer-readable media exclude media such as energy, carrier signals, electromagnetic waves, and signals per se.

The computer-readable media 118 may be used to store any number of functional components that are executable by the processor(s) 116. In many implementations, these functional components comprise instructions or programs that are executable by the processors 116 and that, when executed, specifically configure the one or more processors 116 to perform the actions attributed above to the source computing device 102. Functional components stored in the computer-readable media 118 may include an encoding program 126 that may be executed to embed additional data into a main audio content. In addition, in some cases, one or more additional programs (not shown) may be included at the source computing device(s) 102, such as for controlling the streaming, broadcasting, or other distribution of the audio content, or the like.

In addition, the computer-readable media 118 may store data used for performing the operations described herein. Thus, the computer-readable media 118 may store or otherwise maintain one or more content determining machine-learning models (MLMs) 128 and associated training data, testing data, and validation data, as model building data 130. Examples of machine-learning models that may be used in some implementations herein may encompass any of a variety of types of machine-learning models, including classification models such as random forest and decision trees, regression models, such as linear regression models, predictive models, support vector machines, stochastic models, such as Markov models and hidden Markov models, deep learning networks, artificial neural networks, such as recurrent neural networks, and so forth. Accordingly, the machine-learning models 128 and other machine-learning models described herein are not limited to a particular type of machine-learning model.

As one example, the encoding program 126 may include a model building module that may be executed by the source computing device(s) 102 to build and train a content determining MLM 128. For example, the encoding program 126 may use a portion of the model building data 130 to train the content determining MLM, and may test and validate the content determining MLM 128 with one or more other portions of the model building data 130. Alternatively, in other cases, a separate model building program may be provided. In addition, in some examples, the computer-readable media 118 may store additional content 132, which may be content that may be selected to be embedded into main audio content 134, linked to by a link embedded in the main audio content 134, or the like.

The source computing device 102 may also include or maintain other functional components and data not specifically shown in FIG. 13, such as other programs and data, which may include programs, drivers, etc., and the data used or generated by the functional components. Further, the source computing device 102 may include many other logical, programmatic, and physical components, of which those described above are merely examples that are related to the discussion herein.

The communication interface(s) 120 may include one or more interfaces and hardware components for enabling communication with various other devices, such as over the network(s) 106. For example, communication interface(s) 120 may enable communication through one or more of the Internet, cable networks, cellular networks, wireless networks (e.g., Wi-Fi) and wired networks (e.g., fiber optic and Ethernet), as well as close-range communications, such as BLUETOOTH®, BLUETOOTH® low energy, and the like, as additionally enumerated elsewhere herein. In addition, in some examples, the communication interfaces may enable communication over broadcast or satellite radio networks, such a AM radio, FM radio, shortwave radio, satellite radio, or the like.

The source computing device 102 may further be equipped with various input/output (I/O) devices 122. Such I/O devices 122 may include a display, various user interface controls (e.g., buttons, joystick, keyboard, mouse, touch screen, etc.), audio speakers, connection ports and so forth. For example, the user interface 138 may be presented on a display (not shown in FIG. 1) associated with the source computing device 102, and interacted with using or more of the I/O devices 122.

The audio encoder 124 may be an analog encoder, a digital encoder, or may include both an analog encoding circuit and a digital encoding circuit for embedding data in analog audio content and digital audio content, respectively. For example, the analog encoding circuit may be used to encode embedded data into analog audio content, such as may be modulated and broadcasted via radio carrier waves. Additionally, or alternatively, the digital encoding circuit may be used to encode embedded data into digital audio content that may be transmitted, streamed, downloaded, delivered on demand, or otherwise sent over one or more networks 106.

The one or more networks 106 may include any suitable network, including a wide area network, such as the Internet; a local area network, such an intranet; a wireless network, such as a cellular network, a local wireless network, such as Wi-Fi and/or close-range wireless communications, such as BLUETOOTH®; a wired network; or any other such network, or any combination thereof. Accordingly, the one or more networks 106 may include both wired and/or wireless communication technologies. Components used for such communications can depend at least in part upon the type of network, the environment selected, or both. In addition, in some examples, the one or more networks 106 may include broadcast or satellite radio networks, such as AM radio, FM radio, shortwave radio, satellite radio, or the like. Protocols for communicating over such networks are well known and will not be discussed herein in detail; however, in some cases, the communications over the one or more networks may include Internet Protocol (IP) communications.

In the illustrated example, the source computing device 102 may receive the main audio content 134 from one or more audio sources 136. Examples of audio sources 136 may include one or more live audio sources, such as a person, musical instrument, sounds detected by a microphone, or the like. As one example, a live audio source may include a person speaking into a microphone, a person singing into a microphone, a person playing a musical instrument, and so forth. Additionally, or alternatively, the audio source(s) 136 may include one or more recorded audio sources, which may include songs or other recorded music, pre-recorded podcasts, pre-recorded programs, pre-recorded commercials, other audio content recordings, and the like. Furthermore, in some examples, the audio content may be extracted from multimedia such as recorded video or live video.

The audio encoder 124 may receive the main audio content 134 and encode additional content into the main audio content 134 under the control of the encoding program 126, such as under control of a user interface 138. In some cases, the additional content may include the additional content 132 already maintained at the source computing device 102. In other examples, the additional content may include additional content 142 that is received from the additional content computing devices 112. For example, a user 140 may use the user interface 138 to control the main audio content 134 and the audio encoder 124 for controlling the selection of additional content 132 and/or 142 to embed in or link to the main audio content 134 and to control a timing at which the additional content 132 or 142 is embedded by the audio encoder 124 for encoding the main audio content 134 with embedded data. In some cases, the selection of additional content 132 or 142 to embed or link, and the embedding of the selected additional content may be performed in real time, e.g., as the main content 134 is being created and/or streamed live.

In some cases, the user 140 may employ the user interface 138, which may be presented on a display associated with the source computing device 102, to determine additional content 132 or 142 to be embedded in the main audio content 138. For example, the encoding program 126 may receive the main audio content 134 and may use speech to text recognition for transcribing the main audio content 134 to produce a transcript. The encoding program 126 may execute one or more algorithms to automatically recognize keywords (e.g., words or phrases) that may be used for associating particular pieces of additional content 132 or 142 with a particular timing in a timeline of the main audio content 134. For instance, the encoding program may automatically recognize certain keywords in the transcript, may highlight these keywords in the user interface 138, may provide statistics related to the keywords or the like, and may enable filtering of the keywords such as by a user selection or other techniques. In some examples, the encoding program 126 may execute a content determining MLM 128 for recognizing keywords of interest in the transcript. The user interface 138 may send one or more keywords and request for additional content 146 to the additional content computing devices 112 to request the additional content 142.

The additional content computing devices 112 may include computing devices of one or more entities that may be configured to provide additional content 142 in response to receiving the keyword(s) and request for additional content 146. For example, the additional content computing devices 112 may include an additional content selection program 148 and an additional content database 150. In response to receiving a keyword and request for additional content 146, the additional content selection program may determine additional content 142 such as by searching the additional content database 150 for additional content 142 that is relevant to the keyword received from the source computing device 102.

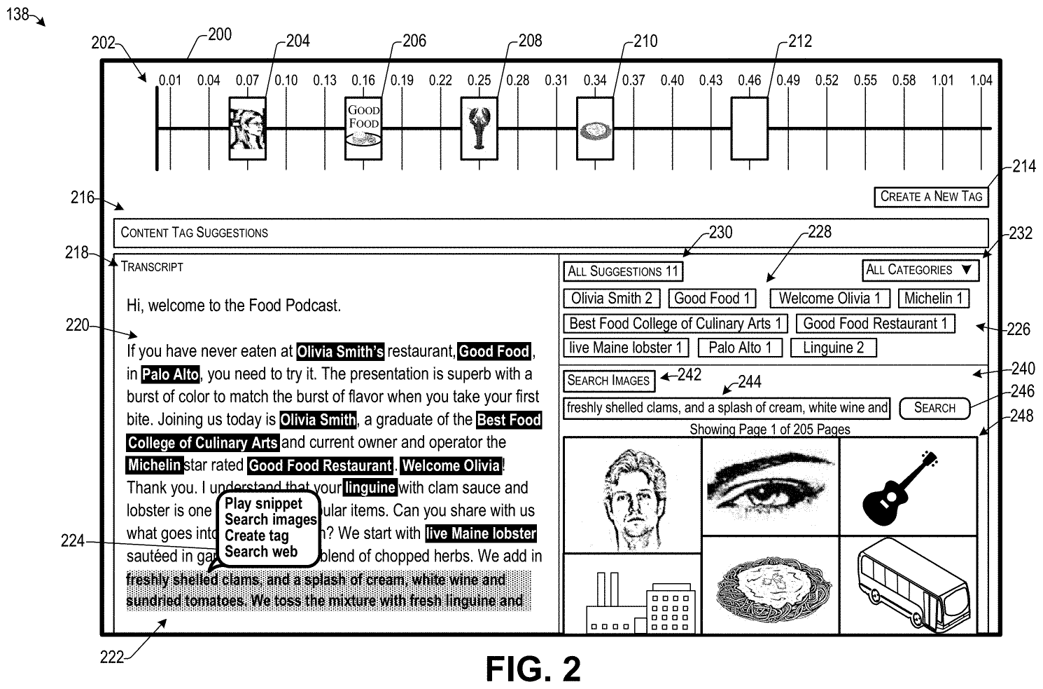

Based on finding one or more pieces of additional content 142 in the additional content database base 150, the additional content selection program 148 may send the selected additional content 142 to the requesting source computing device 102. The user interface 138 may receive and display the additional content 142 received from the one or more additional content computing devices 112, and in some examples the user 140 may decide whether or not to include the additional content as embedded data or link data in the main audio content 134. In other examples, the encoding program 126 may automatically decide which additional content 132 or 142 to associate with the main audio content 134. Additional details of the user interface 138 and the additional content selection techniques are discussed below with respect to FIG. 2.

In some examples, the additional content 132 or 142 selected through the user interface 138 may be embedded, or a link thereto may be embedded, in the main audio content 134 by the audio encoder 124 to create the enhanced audio content with embedded data 154. For example, the user interface 138 may cause the additional content or the link to be embedded in the main audio content 134 as embedded data at a desired location and/or timing in the main audio content 134. In some examples, the embedded data may include one or more of a start-of-frame indicator, a universal ID assigned to each unique or otherwise individually distinguishable piece of audio content, a timestamp, location information, a station ID or other audio source ID, and an end-of-frame indicator. In addition, the embedded data may include content such as text, images, links, or the like, as discussed elsewhere herein.

As mentioned above, the embedded data may include one or more links which act as pointers to linked additional content stored at one or more network locations. For example, the source computing device 102 may send linked additional content 156 over the one or more networks 106 to the one or more service computing devices 110. For instance, in the case of data content that is too large to include as a payload to be embedded in the main audio content 134, the linked additional content 156 may be sent to the service computing device(s) 110, and a hyperlink or other pointer to the linked additional content 156 may be embedded in the main audio content 134 to create the enhanced audio content with embedded data 154 so that the linked additional content 156 may be retrieved by an electronic device 104 of a consumer 155 following extraction of the embedded data from the create the enhanced audio content with embedded data 154.

In implementations herein, a large variety of different types of electronic devices 104 may receive the enhanced audio content with embedded data 154 distributed from the source computing device(s) 102, such as via radio reception, via streaming, via download, via sound waves, or through any of other various reception techniques. For example, the electronic device 104 may be a smart phone, laptop, desktop, tablet computing device, connected speaker, voice-controlled assistant device, vehicle radio, or the like, as additionally enumerated elsewhere herein, that may be connected to the one or more networks 106 through any of a variety of communication interfaces, e.g., as discussed above.

The electronic device 104 in this example may execute an instance of a client application 157. The client application 157 may receive the enhanced audio content with embedded data 154, and may decode or otherwise extract the embedded data as extracted data 158. In some examples, the client application 157 may include a streaming function for receiving the enhanced audio content with embedded data 154 as streamed content and playing the received content over one or more speakers 160. Alternatively, in some examples, the client application 157 may receive the audio content as sound waves through a microphone 162. As still another example, the electronic device may receive the enhanced audio content with embedded data 154 as a broadcast radio signal, such as an AM, FM or satellite radio signal. Numerous other variations will be apparent to those of skill in the art having the benefit of the disclosure herein.

When the client application 157 on the electronic device 104 receives the enhanced audio content with embedded data 154, the client application 157 may extract extracted data 158 from the received audio content using the techniques discussed additionally below. Following extraction of the extracted data 158, the client application 157 may perform any of a number of functions, such as presenting information associated with the extracted data 158 on a display 161 associated with the electronic device 104, contacting the service computing device(s) 110 over the one or more networks 106 based on information included in the extracted data 158, and the like. As one example, the extracted data 158 may include text data, image data, and/or additional audio data that may be presented by the client application 157 on the electronic device 104.

As another example, the extracted data 158 may include timestamp information, information about the audio content, and/or information about the audio source 136 from which the main audio content 134 was received. In addition, the extracted data 158 may include a link or other pointer, such as to a URL or other network address location, for the client application 157 to communicate with over the one or more networks 106. For instance, the extracted data 158 may include a URL or other network address of the one or more service computing devices 110 as part of a pointer included in the embedded data. In response to receiving the network address, the client application 157 may send a client communication 164 to the service computing device(s) 110. For example, the client communication 164 may include the information about the audio content and/or the audio source 136 or source location 114 from which the main audio content 134 was received, and may further include information about the electronic device 104, a user account, and/or a user 155 associated with the electronic device 104. For instance, the client communication 164 may indicate, or may enable the service computing device 110 to determine, a location of the electronic device 104, demographic information about the user 155, or various other types of information.

In response to receiving the client communication 164, the service computing device(s) 110 may send linked additional content 156 to the electronic device 104. For example, the linked additional content 156 may include audio, images, multimedia, such as video clips, coupons, advertisements, or various other digital content that may be of interest to the user 155 associated with the respective electronic device 104. In some cases, the service computing device(s) 110 may include a server program 159 and a logging program 160. The server program 159 may be executed to send the linked additional content 156 to an electronic device 104 or the other electronic devices herein in response to receiving a client communication 164 from the client application on the respective electronic device 104, such as based on a pointer included in the extracted data 158.

In some examples herein, a pointer may include an ID that helps identify the audio content and corresponding tags for the audio content. For instance, a pointer may be included in the information embedded in the audio content itself instead of storing a larger data item, such as an image (e.g., in the case of a banner, photo, or html tag) a video, an audio clip, and so forth. The pointer enables the client application to retrieve the correct linked additional data 156 at the correct context, i.e., at the correct timing in coordination with the enhanced audio content with embedded data 154 currently being received, played, etc. For example, the client application 157 (i.e., including a decoder) may send an extracted universal ID to the service computing device(s) 110 (e.g., using standard HTTP protocol). The service computing device(s) 110 identifies the enhanced audio content 154 that is being received by the electronic device 104, and a server program 166 may send corresponding linked additional content 156, such as via JSON or other suitable techniques, such that the corresponding linked additional content 156 matches the contextual information for that particular main audio content. Since the universal ID is received with the enhanced audio content with embedded data 154, the audio content and its corresponding linked additional content 156 can be located without an extensive database search.

In addition, when the service computing device(s) 110 receives the client communication 164 from the client application 157, an analytics program 168 may make an entry into an analytics data structure (DS) 170. For example, the entry may include information about the enhanced audio content 154 that was received by the electronic device 104, information about the source location 114 and/or the audio source 136 from which the main audio content 134 was received, information about the respective electronic device 104, information about the respective client application 157 that sent the client communication 164, and/or information about the user 155 associated with the electronic device 104, as well as various other types of information. Accordingly, the analytics program 170 may maintain the analytics data structure 161 that includes comprehensive information about the audience reached by a particular piece of main audio content 134 distributed from the source computing device(s) 102. In some cases, the server program 166 may be executed on a first service-computing device 110 and the analytics program 168 may be executed on a second, different service-computing device 110, and each service computing device 110 may receive a respective client communication 164. In other examples, the same service computing device 110 may include both the server program 166 and the analytics program 168, as illustrated.

As another example, in some cases, the client application 157 on the electronic device 104 may generate a transcript of at least a portion of received main audio content, such as by using natural language processing and speech-to-text recognition. The client application 157 may spot keywords in the transcript, such as based on a keyword library, or through any of various other techniques. The client application 157 may apply a content selection machine-learning model (MLM) 174 or other algorithm for selecting one or more keywords to employ for fetching additional content in real time for presenting the additional content on the electronic device 104. For example, the client application 157 may send selected keyword(s) 176 to the additional content computing device(s) 112 which may be configured to provide selected additional content 178 to the client application 157 based on receiving the selected keyword(s) 176 from the client application 157. In some cases, at least some of the additional content computing devices 112 may be operated by third party entities that provide the selected additional content 178. Alternatively, in some examples, the client application 157 may send the selected keyword(s) 176 to request the selected additional content 178 from the service computing device(s) 110, rather than from the additional content computing device(s) 112.

The client application 157 may receive the selected additional content from the third party computing device(s) 112 while the main audio content is being presented on the electronic device 104, and may present the selected additional content on the electronic device 104 of the consumer 155 according to a timing determined by the client application 157 based on the transcript. Furthermore, in some cases, the selected additional content 178 may include one or more selectable links or other interactive content such that the user 155 may select the one or more selectable links or other interactive content. For example, a response tracking program 180 at the additional content computing device(s) 112 may determine which selected additional content 178 is sent to the electronic device 104, and may further determine whether the user interacts with the selected additional content 178, such as if the user selects one of the links therein or otherwise interacts with the selected additional content 178 when presented on the respective electronic device 104.

The keyword selection MLM 174 may be trained at least in part using information from the model building data 130 and the user interface 138 for training the content determining MLM(s) 128 for selecting keywords and corresponding additional content. The selected keywords and/or selected additional content identified and displayed may be the result of MLM learning of the training data interaction. As one example, the content selection MLM 174 may select additional content that may be determined based on a lowest error that is back propagated to converge to a minimum cost value using a machine-learning pipeline.

When trained, tested and validated, the keyword selection MLM 174 may be deployed in association with the client application 157 for selecting keywords in the main audio content or content added to the main audio content. As one example, informational audio content may be spliced into the main audio content as discussed below, such as before, during or following the main audio content, and the client application 157 may present corresponding visual content concurrently on the display 161 for at least the informational portion added to the main audio content. For example, by employing real-time audio transcription technology, the client application 157 on the respective electronic device 104 may identify, request, receive and display selected additional content 178, such as visual content, on the display 161 of the electronic device in real time and may also present selected additional audio content, such as through the speakers 160 of the electronic device 104. Thus, in some examples, the selected additional content 178 may include additional audio content that is played concurrently with presentation of visual content. For example, the client application 157 may briefly cease playback of the main audio content, and may play the audio content of the selected additional content while the visual portion of the selected visual content is presented on the display 161. For instance, the speech/media file is replaced by the audio data that is received via stream or broadcast. Further, when generating a transcript, this received data may be sent to the transcription engine in small segments.

FIG. 2 illustrates an example of the user interface 138 according to some implementations. For instance, the user interface 138 may be used for automatically associating additional content (tags) with the main audio content according to some implementations. For example, the user interface 138 may be generated and presented by the encoding program 126 on a display 200 associated the source computing device(s) 102 discussed above with respect to FIG. 1.

In the illustrated example, an upper part of the user interface 138 may include a timeline 202 that represents a plurality of points in time of the main audio content 134 discussed above with respect to FIG. 1. For instance, the timeline 202 in this example illustrates three second intervals in the main audio content 134; however larger or smaller intervals may be represented in other examples. The timeline 202 further includes representations of additional content that has been selected to be associated with the main audio content 134. For example, as illustrated at 204, first visual content, which may be an image, GIF, video clip, or the like, has been selected to be associated with the main audio content at the 7 second mark in the timeline 202 of the main audio content 134. Similarly, as indicated at 206, second visual content has been associated with the 16 second mark in the timeline 202; as indicated at 208, third visual content has been associated with the 25 second mark in the timeline 202; and as indicated at 210, fourth visual content has been associated with the 34 second mark in the timeline 202.

In addition, as indicated at 212 an additional content tag that does not yet have additional content associated with the main audio content 134 is being added at the 46 second mark in the timeline 202. For instance, according to some examples herein, the content tags may be added automatically by the encoding program 126. Alternatively, the user 140 may manually add tags to selected locations in the timeline 202 such as by selecting a “create a new tag” virtual control 214 to manually add a new content tag location to a selected mark in the timeline 202. Furthermore, in some examples, such as in the case that the user interface 138 is being used to associate additional content with the main audio content 134 in an offline mode, the timeline 202 may be scrolled to reach the end of the main audio content 134 for including additional content tags at selected points in the main audio content 134. Alternatively, in the case that the additional content is being associated with the main audio content 134 in real time, e.g., while the main audio content 134 is being prepared for distribution, such as in the case of a live broadcast or the like, the timeline 202 may scroll from right to left automatically, such as in sequence with the progression of the main audio content 134.

The user interface 138 herein enables the additional content to be determined and associated with the main audio content 134 automatically, semi-automatically, or manually. The user interface portion and virtual controls for determining the additional content to be associated with the main audio content are illustrated in the lower portion 216 of the user interface 138. For instance, as the additional content is determined using the lower portion 216 of the user interface 138, the selected additional content may be visualized in the timeline 202.

The user interface 138 may present a transcript 218 of the main audio content 134 that may be transcribed using natural language processing and speech to text recognition. In addition, the encoding program 126 may automatically identify keywords of interest in the transcript 218 to be used for determining the additional content to be associated with the main audio content 134. For instance, as indicated at 220, keywords selected by the encoding program 126 may be highlighted in the transcript 218. In some examples, the encoding program 126 may access a library of keywords and/or may employ the content determining machine-learning model 128 for determining the keywords 220 to highlight in the transcript 218.

An area 226 on the right side of the user interface 138 may present the selected keywords along with a count for each selected keyword as indicated at 228. For example, the keyword “Olivia Smith” is indicated to have occurred in the transcript two times thus far, and the keyword “good food” is indicated to have occurred one time and so forth. In addition, the area 226 may include a total for all suggested keywords as indicated at 230, and may further include an option for filtering the keywords presented according to category as indicated at 232. For example, depending on the type of audio of the main audio content 134 and/or a context of the main audio content 134, various subcategories may be provided for filtering the keywords identified automatically by the encoding program 126.

In addition, in the transcript 218, as indicated at 222, a user 140 may manually highlight or otherwise select a portion of the text of the transcript 218, such as for performing one or more actions with respect to the selected text, e.g., such as provided in a pop-up window 224. Examples of possible actions may include playing a snippet of the selected text, forming a search for images related to the selected text, creating a content tag related to the selected text, or searching the web for content related to the selected text.

Furthermore, the right side of the user interface 138 also includes an action area 240 that may correspond to an action selected in the pop-up bubble 224. In this example, as indicated at 242, suppose that the user 140 has selected the option to search images related to the selected text, at least a portion of which has been auto filled into a search field 244. Accordingly, selection of a search button 246 may cause images 248 located related to the selected text to be presented in the area 240. For example, the user 140 may manually scroll through the retrieved images 248 to select one of the images to add as a content tag, such as at the 46 second mark of the timeline 202.

Alternatively, in the automated implementation of the user interface 138, the encoding program 126 may use the content determining MLM 128 to select a keyword and to select an image or other content associated with the keyword to include in the content tag 212 at the 46 second mark of the timeline 202. In some examples, the user 140 may review and change one or more of the selections made by the encoding program 126 based on the content determining MLM 128. The changes made by the user 140 may be recorded as part of the model building data 130 discussed above with respect to FIG. 1, and may be used to further train and update the content determining MLM 128 to further improve the accuracy of the content determining MLM 128.

Accordingly, some examples herein provide a method that automates a process of determining additional content to associate with the main audio content 134 by identifying relevant keywords in the main audio content 134 and selecting corresponding content to associate with the main audio content 134. The examples herein may work in real time as the main audio content 134 is being generated, listened to, played, streamed, etc. For example, as the main audio content 134 is being processed for broadcast, streaming, or other distribution, the content tags may be generated automatically by the encoding program 126 and may be automatically added to a location in the timeline 202 that corresponds to the audio content that caused the content tag to be generated. For example, the user 140 may be able to review the tags being automatically added and may have time to remove or edit the content tags, if desired, as described above.

In some examples, the encoding program 126 may be configured to automatically transcribe the main audio content 134, determine relevant keywords in the transcription, determine appropriate content to associate with the main audio content 134 and add the content to the audio timeline 202 at the corresponding location for being encoded into the audio content by the audio encoder 124 at the specified timing of the main audio content 134. Accordingly, the main audio content 134 may be encoded with the selected additional content to generate enhanced audio content as discussed above with respect to FIG. 1. Subsequently, the enhanced audio content is received at an electronic device 104 of a consumer 155 and may be decoded by the electronic device 104 to receive the additional content at the electronic device 104 of the consumer 155. Furthermore, as discussed above with respect to FIG. 1, in some cases, the additional content may include a call to action that causes the client application 157 on the electronic device 104 to perform an action, such as obtaining or otherwise accessing additional content over the Internet or other network.

As the encoding program 126 transcribes the main audio content, the encoding program 126 may determine additional content to be associated with the timeline 202 of the main audio content 134 based on several criteria which may include learning from past actions of the user 140 with respect to of the selected content through machine-learning techniques. For example, if the user has accepted or rejected a selected piece of additional content in the past, machine learning may be used to capture the user's feedback to improve the accuracy of the machine-learning model so that more accurate additional content is selected by the machine-learning model in the future.

In addition, the encoding program 126 may use combinations of machine learning and deep learning techniques for identifying useful keywords in a transcript such as based on names of people, places, movies, consumer goods, works of art and the like. In addition, a predefined set of keywords may be provided to the encoding program 126 which may be used for determining selected keywords. For example, the source computing device 102 may include a keyword library that may be accessed by the encoding program 126 and that may include popular and trending topics, news, personalities, and so forth.

Additionally, in some examples, the keyword selection may be based on metadata associated with the main audio content 134. For example, a name, genre, topic, or the like, of the main audio content 134 may be used to spawn closely related keywords that may be selected for determining related content for the main audio content 134. As one example, the name of an artist included in metadata for the main audio content 134 can trigger links or images to news articles, images, etc. related to the artist. Accordingly, the suggested additional content may be based on the metadata present in the main audio content 134, such as name of file, genre, artist, and the like.

Furthermore, in some examples, relevant keywords may be supplied by the creator of the main audio content 134. For example, the creator of a podcast, article, or the like may sometimes designate certain keywords that are representative of the topic, issues, or the like of the content. The encoding program 126 may store in the keyword library very frequently used sets of keywords that may be used for selecting additional content to associate with the main audio content 134. As one example, the presence of these keywords, when detected in the main audio content 134 may trigger a selection of additional content for the location on the timeline at which the keyword occurs. In some examples, the encoding program 126 may access and update a set of rules for making decisions based on best practices or information learned from prior experience/user changes which may then be applied so as to allow the encoding program 126 to make more accurate selections as time goes on.

Accordingly, implementations herein may optimize the selection process for selecting additional content to include with the main audio content 134 by learning based on past actions performed by a user. When one or more selected content tags have been identified and placed in the timeline 202 by the encoding program 126, the encoding program 126 may subsequently rank the selected content tags based on any feedback regarding interaction received with respect to the selected tags from the consumers 155. In some examples, the highly ranked selected content tags may be integrated into the user interface 138 such as in the form of a new callout page, pop-up window or other suitable interface that does not impede the creative workflow. In addition, as mentioned above, when the user 140 selects a particular one of the content tags, this may be used as an input to the machine-learning model for future training.

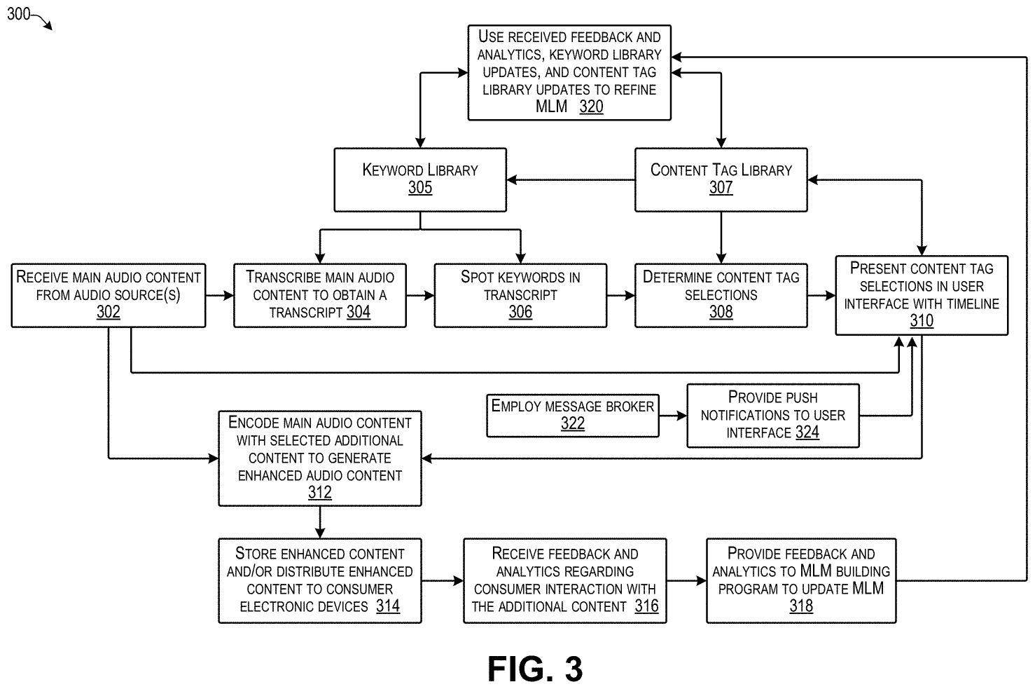

FIGS. 3, 4 and 8 are flow diagrams illustrating example processes according to some implementations. The processes are illustrated as collections of blocks in logical flow diagrams, which represent a sequence of operations, some or all of which can be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the processes are described with reference to the environments, architectures and systems described in the examples herein, although the processes may be implemented in a wide variety of other environments, architectures and systems.

FIG. 3 is a flow diagram illustrating an example process 300 for selecting content to be encoded into main audio content according to some implementations. For example, the process 300 may be performed by one or more source computing devices 102 executing the encoding program 126, e.g., as discussed above with respect to FIGS. 1 and 2. Alternatively, in other examples, a separate tag selection program may be provided and executed on the source computing device 102. As mentioned above, the process 200 may be performed for automatically selecting content tags for a particular piece of source audio content 134. In some examples, keyword selection may depend in part on the use of neurolinguistic programming.

At 302, the computing device may receive the main audio content from an audio source for processing. For example, the main audio content may be any type of audio content such as podcasts, music, songs, recorded programming, live programming, or the like. Additionally, in some examples, the audio content may be a multimedia file or the like that includes audio content.

At 304, the computing device may transcribe the main audio content to obtain a transcript of the main audio content. For example, the computing device may apply natural language processing and speech to text recognition for creating a transcript of the speech and detectable words present in the main audio content.

At 306, the computing device may spot keywords in the transcript. In some examples, the computing device may access a keyword library 305 that may include a plurality of previously identified keywords (i.e., words and phrases previously determined to be of interest, such as based on human selection or other indicators) that may be of interest for use in locating additional content relevant to the main audio content. Additionally, in some examples, the keyword spotting may be based on metadata associated with the particular received main audio content or based on various other techniques as discussed above.

At 308, the computing device may determine one or more content tag selections based on the keywords spotted in the transcript in 306 above. In some examples, the computing device may access a content tag library 307 that may include a plurality of additional content used in the past that corresponds to the respective keywords. For instance, the computing device may sort the keywords and corresponding additional information based on a history of all content tags created and/or deleted and/or discarded by a human user, and further based on a history of all content tags present in an account corresponding to the main audio content. Furthermore, if any specific keywords and/or additional content have been provided with the particular main audio content, those keywords/content may be selected. In some examples, one or more indicators in the history of the additional content may be used to rank the additional content. Examples of positive indicators for increasing a rank of additional content may include selection of the content or a keyword by a human user on one or more occasions, receiving an indication of consumer interaction with the additional content, or other factors as discussed elsewhere herein. In some examples, block 308 and/or block 306 may be performed at least in part using one or more trained content determination machine-learning models 128 as discussed above e.g. with respect to FIGS. 1 and 2.

At 310, the computing device may present the user interface 138, to enable a user to view the keywords and/or content selected by the encoding program 126. For example, the user interface 138 may show the keywords and content that have been automatically selected. The user may employ the user interface 138 to add or remove keywords and accept, reject, or modify selected additional content selected for the content tags. In addition, the user interface 138 may enable the user to select and create new content tags and insert these into a desired location in the timeline for the main audio content. The content determination machine-learning model 128 may be trained additionally based on the user actions with respect to the selected content tags and any newly created content tags.

At 312, the computing device may encode the main audio content with the selected additional content to generate enhanced audio content. For example, the computing device may employ the audio encoder 124 to embed the selected additional content and/or links to the selected additional content into a psycho acoustic mask of the main audio content without affecting the audio quality of the main audio content as described in the documents incorporated herein by reference.

At 314, the computing device may store the enhanced content and/or distribute the enhanced content to consumer electronic devices. For instance, as discussed above with respect to FIG. 1, the enhanced audio content with the embedded additional content may be distributed to a large number of consumer electronic devices that execute the client application. The client application may extract the embedded content from the received enhanced content to enable a consumer to interact with the additional content. In some examples herein, as additionally discussed below, the client application may also apply a machine-learning model for identifying keywords in the audio content received at the electronic device 104 for obtaining additional content associated with the main audio content, such as from one or more third party content provider computing devices.

At 316, the computing device may receive feedback and analytics regarding consumer interaction with the additional content. For example, the computing device may receive feedback and analytics regarding the additional content from the service computing devices 110 and/or the additional content computing devices 112.

At 318, the computing device may provide the feedback and analytics to a machine-learning model building module of the encoding program 126, such as to enable the machine-learning model building module of the encoding program 126 to use received feedback to refine the machine-learning model 128. The feedback and analytics may also be used to update the content tag library 307 and the keyword library 305.

At 320, the computing device may use the receive feedback and analytics any keyword library updates, and any content tag library updates to update and refine the machine-learning model 128. For example, the content determining machine-learning model 128 may be continually updated and refined to improve the accuracy of the model based on received feedback, analytics, user inputs and the like.

At 322, the computing device may employ a message broker for performing asynchronous processing. For example, the message broker may be a module executed by the encoding program 126 that handles receiving a message from a first process and delivering the message to a second process. Accordingly, asynchronous messaging may be used to establish communication between services. As one example, in the case that the main audio content is a long audio file, the content tag selection process may continually update content tag library 307 and the keyword library 305. When a keyword is found, an event may be sent via the message broker. Upon receiving this event, the encoding program 126 may update the user interface 138. Accordingly, the message broker enables asynchronous communication between different blocks in the process 300, and may allow immediate application of the inferred results.

At 324, the computing device may provide push notifications to the user interface. For example, A push notification may include a message that pops up or is otherwise presented on the user interface 138. The push notification may be sent based on receiving a relevant update. For example, a user 140 does not have to be using the encoding program 126 at the time that a push notification is generated. The push notifications may provide various information to the user 140. For example, a push notification may indicate the relevant results of the latest inference from the message broker, and/or may urge a user 140 to take an action, such as accepting or declining a tag content selection.

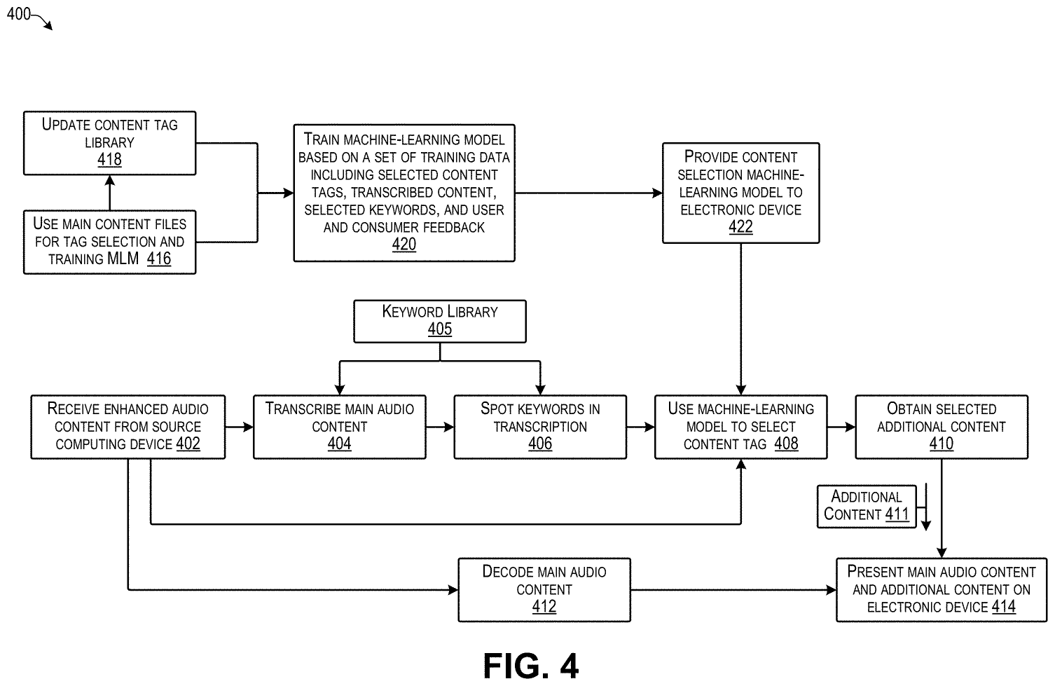

FIG. 4 illustrates an example process 400 that may be executed by the electronic device 104 for presenting additional content on the electronic device 104 according to some implementations. For example, the process 400 may be performed by the electronic device 104 executing the client application 157 as discussed above with respect to FIG. 1. In this example, an intelligent version of the tag suggestion algorithm may be executed at the decoder side, e.g., by the client application 157 at the electronic device 104 of a consumer 155.

As one example, the client application 157 may perform real time audio transcription of received audio content to identify keywords and perform content tag selection in a manner similar to that described above with respect to the user interface 138 on the source computing device 102. Based on the identified key words, the client application 157 may retrieve and present additional content relevant to the main audio content 134 in real time. In this example, the received main audio content 134 may or may not have embedded data contained therein, and may be received via streaming, broadcasting or the like. The received main audio content 134 may be wholly or partially transcribed by the client application 157. As one example, data embedded in the main audio content may indicate which portions of the main audio content are to be transcribed by the client application and used for retrieving additional content over the one or more networks 106. The content selection machine-learning model 174 may be used by the client application 157 for determining additional content to request based on keywords identified in the transcript of the main audio content. Thus, the additional content identified and subsequently presented on the electronic device 104 may be determined based on machine-learning and training data interaction. For instance, a most likely content tag is determined based on a lowest error that is back propagated to converge to a minimum cost value using machine-learning pipeline, such as based on neural network or the like. The additional content selection process discussed above with respect to FIGS. 1-3 may be used to also provide training data for the content selection MLM 174 on the electronic device 104.

At 402, the electronic device may receive the main audio content. For example, the main audio content may be received by streaming, broadcast radio, or any of various other techniques discussed herein.

At 404, the electronic device may transcribe at least a portion of the received main audio content. As mentioned above, in some cases data may be embedded in the received main audio content to indicate to the client application which portions of the main audio content to transcribe.

At 406, the electronic device may use a keyword library 405 to spot keywords in the transcription. For example, the keyword library 405 may be similar to the keyword library 300 by discussed above with respect to FIG. 3, and may be used in a similar manner for spotting keywords of interest in the transcription of the main audio content and any metadata associated with the main audio content.

At 408, the electronic device may use a machine-learning model to select additional content to present on the electronic device during playback of the received main audio content. For instance, the client application 157 may employ the content selection MLM 174 to select keywords and corresponding additional content.

At 410, the electronic device may obtain the selected additional 411 content for presentation on the electronic device during playback of the main audio content. In some examples, the selected additional content may already be maintained on the electronic device in other examples, the selected additional content 411 may be retrieved from the service computing devices 110 or the additional content computing devices 112.

At 412, the electronic device may decode the main audio content in its entirety while the additional content 411 is being selected and retrieved.

At 414, the electronic device may present the main audio content and the additional content according to a timing based on the timeline of the main audio content.

In in addition, blocks 416-422 may be performed by the source computing device 102 or other suitable computing device for training and providing a machine-learning model to the electronic device 104, such as the content selection MLM 174.

At 416, the computing device may use main content files for tag selection and training the machine-learning model.

At 418, the computing device may update the content tag library, e.g., as discussed above with respect to FIG. 3.

At 420, the computing device may train the content selection machine-learning model 174 based on a set of training data including selected content tags, transcribe content, selected keywords, and user consumer feedback e.g., as discussed above with respect to FIG. 3.

At 422, the computing device may provide the content selection machine-learning model 174 to the electronic device 104. As one example, the content selection machine-learning model 174 may be included with the client application 157 when the client application 157 is downloaded to the electronic device 104.

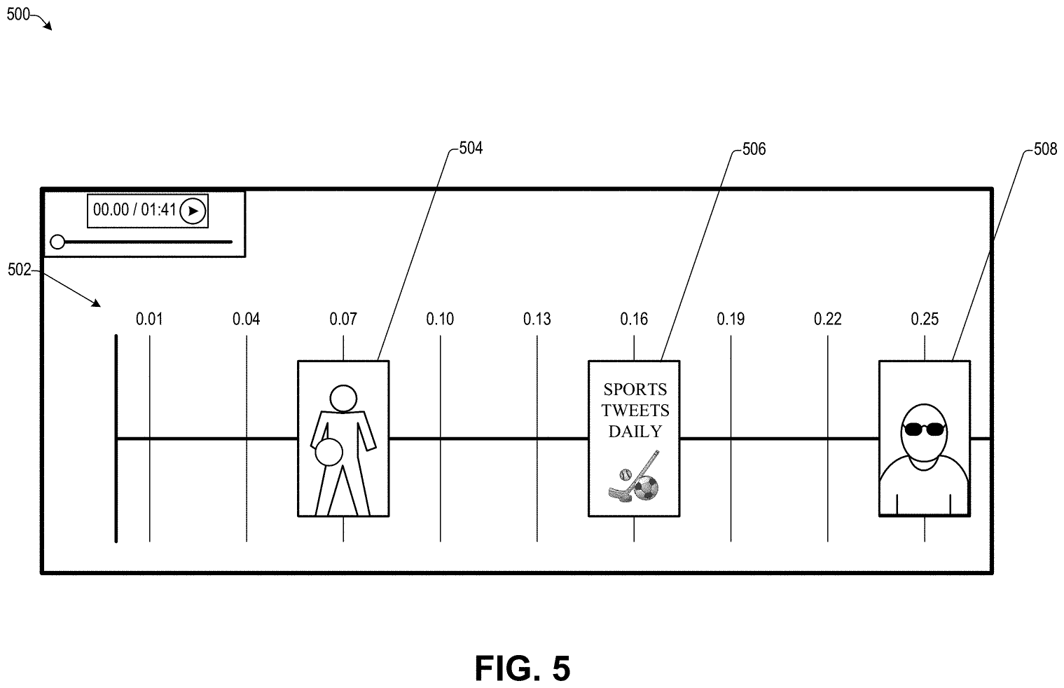

FIG. 5 illustrates an example timeline portion 500 for a main audio content according to some implementations. In this example, three pieces of visual information are associated with the timeline 502 for the main audio content. In particular, time line includes the content tags, i.e., a first content tag 504 including first visual information is associated with a 7 second mark on the timeline 502, a second content tag 506 including second visual information is associated with a 16 second mark on the timeline 502, and a third content tag 508 including third visual information is associated with a 25 second mark on the timeline 502.

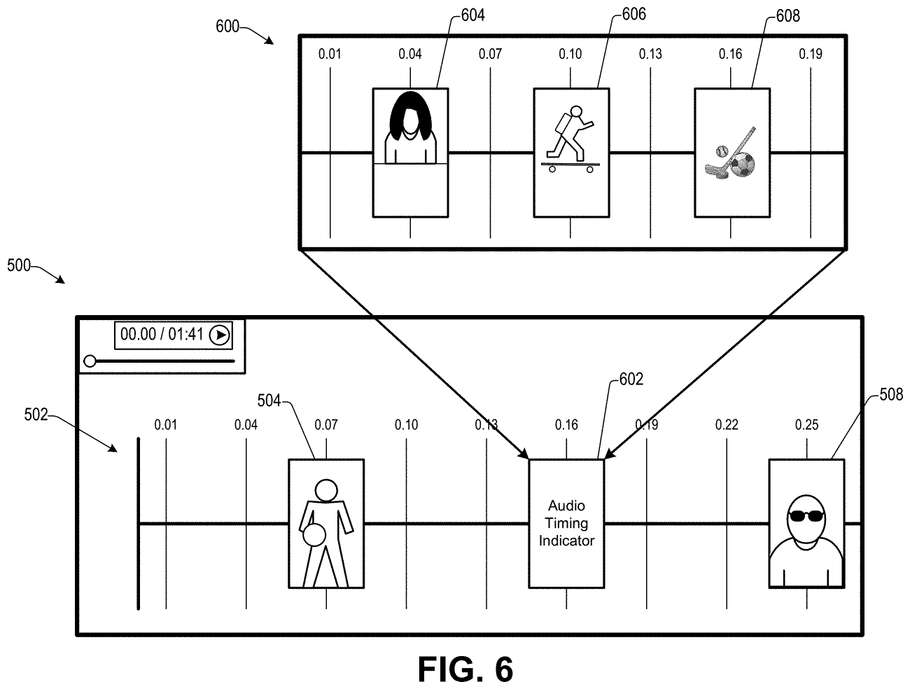

In this example, each content tag 504-508 is made of two layers: a first layer (the audio layer) contains the additional audio that when inserted in the main audio content attaches to the timeline as a playlist; and a second layer (an interactive layer) which is a set of content tags that have one or more pieces of visual information and associated links or other calls to action such as by linking to a URL In the example of FIGS. 5 and 6, an audio tag including identifying information may be included in the main audio content for enabling enhanced content to be accessed according to a certain timing with respect to the main audio content. Thus, some examples may include the ability to add these timing indicators within the main audio timeline and to be able to move, delete or replace these timing indicators, thereby creating a subset of audio content within the main audio content. In the example, of FIG. 5, the content tags 504-508 may be similar to those discussed above, e.g., with respect to FIG. 2.

FIG. 6 illustrates example first timeline portion 500 and a second timeline 600 according to some implementations. This example includes insertion of a second layer into the main audio content layer represented by the first timeline portion 500 for presenting additional audio and visual information with the main audio content represented by the timeline portion 500. For example, in FIG. 6, in the timeline portion 500, the content tag 506 is replaced with a timing indicator 602 that enables an added audio layer of additional audio content represented by the timeline 600 to be inserted into the main audio content represented by the timeline portion 500. For example, an additional 20 seconds of audio content represented by the timeline 600 may be inserted into the timeline portion 500 of the main audio content. In addition, corresponding visual content, such as first visual and/or interactive content 604, second visual and/or interactive content 606, and third visual and/or interactive content 608 may be included with the additional audio content represented by the timeline 600. For example, the first visual and/or interactive content 604 may corresponding to the 4 second mark, the second visual and/or interactive content 606 may correspond to the 10 second mark, and the third visual and/or interactive content may correspond to the 16 second mark in the second timeline 600.

When the main audio content represented by the timeline portion 500 is played on the electronic device 104 of a consumer 155, the main audio content may play up to the 16 second mark in the first timeline portion 500. At that point, the audio timing indicator 602 may cause the client application 157 to begin playing the additional audio content corresponding to the second timeline 600. The additional audio content may play for 20 seconds while the corresponding visual and/or interactive content 604-608 may be presented on the display of the electronic device 104. When the audio second timeline reaches the end of the timeline 600, the client application 157 may begin playing the main audio content again, staring at the 16 second point where it left off Accordingly, implementations herein enable a visual and/or interactive layer to be included with the additional audio layer, such as for displaying enhanced information, which may include one or more of text, images, GIFs, video, selectable links, and so forth. Further, the enhanced information may be placed in a contextual manner with the main audio content, such as at a location based on one or more keywords corresponding to the location.

As mentioned above, the audio tag (including an audio timing indicator 602) may be a subset of the main audio (e.g., part of a playlist) and may have its own associated display visuals with calls to action, such as links that may be activated when the consumer clicks, taps or otherwise selects the link. Additionally, or alternatively, the main audio content may contain, or otherwise have associated therewith, additional visual content and calls to action (e.g., links) as discussed above.

When the consumer 155 plays the main audio content, the main audio content is decoded and an identifier (ID) may be extracted by a decoder, e.g., included with the client application 157. As discussed in the documents incorporated by reference above, the audio may be encoded at two levels, i.e., on the audio frame level (digital) and on the actual audio (analog). An audio fingerprint may be created and a hybrid approach may be used to decode the information embedded in the audio content using a combination of a fingerprint and a “watermark” to determine audio information, thus optimizing on the limited throughput available with the watermark. As one example, the watermark may provide an ID for the audio content, and the fingerprint may be used to provide timing information. This enables association of time stamps with the audio ID, and thereby indicates the timing for displaying additional visual content on a display at a correct timing, as well as playing the additional audio content (e.g., timeline 600) as a discussed above.

Furthermore, in the case that the audio content has not been transcoded, e.g., meaning that the audio content has not been reframed, then due to the digital encoding, it may be possible to obtain the timing information more easily with less computational requirements by extracting data from an unused portion of the frame. However, when the audio content is received via broadcasted radio or through sound waves (e.g., coming through a smart speaker or other audio playback device), then the hybrid method discussed above may be used.

As one example, when the main audio content is received via a digital streaming transmission, the client application 157 may first check to determine whether the digital encoding herein is present in the received audio content. If so, the client application 157 may use decoded data extracted from the main audio content to obtain the ID and timestamps. The client application 157 may use the ID to obtain the additional content details from the service computing device(s) 110.

When the frame has been transcoded (e.g., by the source computing device(s) 102, the service computing device(s) 110, or by transport), then the digital encoding may be lost. In that case, the analog decoder included with the client application 157 may determine a watermark in the audio content to determine an ID associated with the audio content. The client application 157 may use this ID to obtain the fingerprint for the audio content from the service computing device(s) 110 and details of additional content associated with the audio content. The fingerprint may provide the timing information. In particular, the timing information provided by the fingerprint extraction may be used for determining timing for the additional content in situations such as when the audio is received over a radio broadcast or when the audio is received as sound waves (e.g., when the audio is received via the microphone 162). On the other hand, when the audio is received via digital streaming, the timing information may be available in the digital content itself.

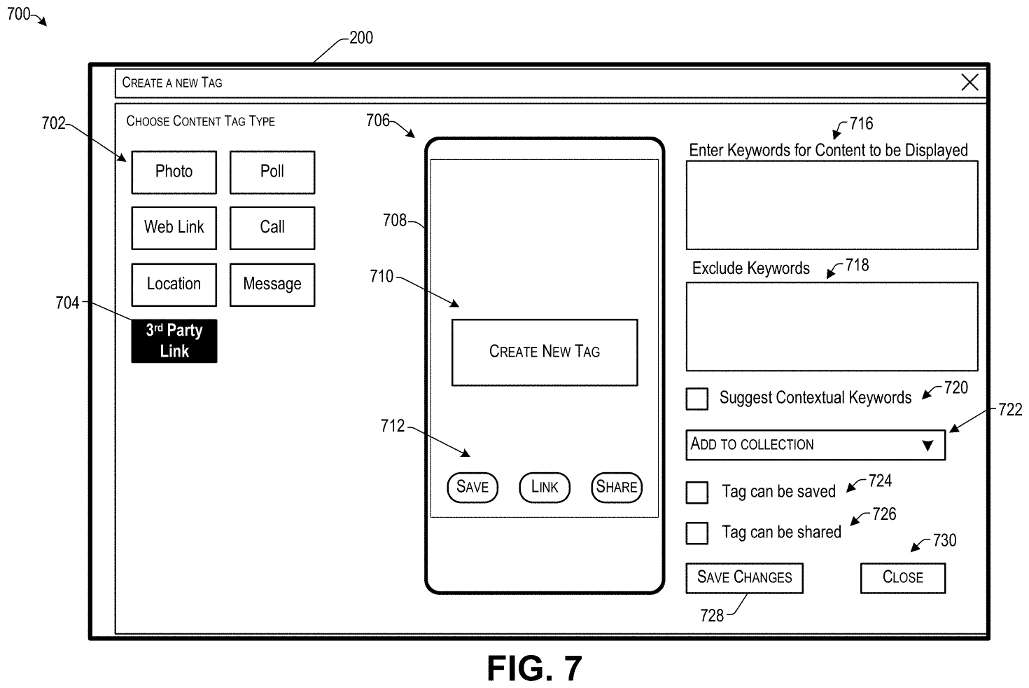

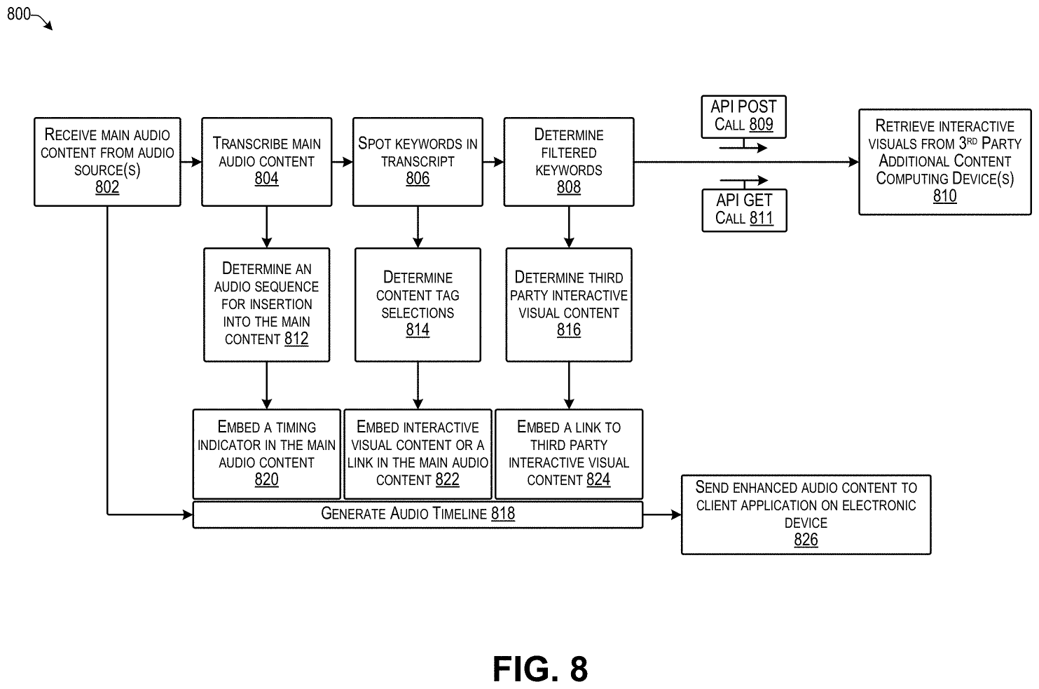

FIG. 7 illustrates an example user interface 700 for associating keywords with content according to some implementations. For instance, the user interface 700 may be presented on a display associated with the source computing device 102 discussed above with respect to FIG. 1. For example, the user interface 700 may be generated by embedding program 126 executing on the source computing device 102. In some cases, the user interface 700 may be used to associate particular desired key words with particular main audio content prior to sending the main audio content to the consumer electronic devices 104. For example, as discussed above with respect to FIG. 4, and as discussed additionally below with respect to FIG. 8, one or more keywords may be selected at the consumer electronic device 104 for obtaining and presenting additional content at the electronic device 104.

In this example, the user interface 700 may include a plurality of virtual controls, as indicated at 702, to enable the user 140 to select a type of additional content tag to embed in the main audio content or otherwise provide in association with the main audio content. Accordingly, the user 140 may select a corresponding virtual control 702 to select a particular type of additional content to embed. Following the selection of the additional content, the user 140 may send the selected data to the audio encoder 124 to be embedded by the audio encoder 124 in the audio content in real time or near real time. Examples of types of additional content that the user 140 may select for embedding in the main audio content include a photo, a pole, a web link, a call, a location, a message, or a third-party link. In this example, suppose that the user 140 has selected the third-party link as indicated at 704.

In this example, the user interface 700 may include an image 706 of an example electronic device, such as a cell phone, to give the user 140 of the user interface 700 an indication of how the embedded data may appear on the screen 708 corresponding to a display 161 of a consumer electronic device 104. The image 706 of the electronic device may further include an indication 710 of a possible location of a tag, and a plurality of virtual controls 712 that may be presented on the electronic device with the content tag information, such as to enable a consumer to save, link or share added content.

In this example, suppose that the user 140 desires to add a link to a third party that is configured to receive one or more selected keywords from an electronic device 104, and return additional content in response, such as visual content, interactive content, audio content, or any combination thereof. Selection of the control 704 may result in additional features being presented on the right side of the user interface 700. For example, a first text box 716 may be presented to enable the user to enter one or more keywords to associate with the main audio content with which the tag will be associated. Further, a second text box 718 may be presented to enable the user 140 to enter one or more keywords that the user does not want associated with the main audio content.

In addition, the user interface 700 may include a selection box 720 that may be selected to allow the client application to suggest contextual keywords a transcript of the main audio content. In addition, the user interface 700 may include a drop-down menu 722 that enables the user 140 to decide whether to add the tag configuration to a collection or not. In addition, the user interface 700 may include a selection box 724 that may be selected to allow the content tag to be saved and a selection box 726 that may be selected to allow the content tag to be shared. In addition, the user interface 700 includes a “save changes” virtual control 728, and a “close” virtual control 730.

In this example, a user 140 may enter one or more desired keywords in the text box 716 and add the entered keywords to the audio timeline of the corresponding main audio content. In some cases, the keywords may be selected in a manner similar to that discussed above with respect to FIG. 2, e.g., by selecting keywords by picking keywords in the vicinity of the timeline where the content tag will be placed with respect to the main audio content. In addition, the users 140 may add their own keywords in addition to keyword selections determined based on the user interface 138 discussed above. Further, the user 140 may also enter keyword exclusions in the text box 718, such as to avoid certain content from being presented on the electronic device 104 of the consumer 155.

When the user 140 has completed adding keywords to the text boxes 716 and/or 718, the user 140 may save the changes by selecting the virtual control 728. The content tag may then be embedded in the main audio content and may include the specified keywords, such as in a JSON tag list associated with the main audio content. For example, JSON is a text based data-interchange format that uses key/value pairs to store and transmit data. As one example, the JSON tag list may be stored at the service computing device(s) 110 as part of the linked additional content 156 for a respective piece of enhanced audio content 154, and may be requested by the client application 157, such as by using a GET API call to a URL, e.g., as in the following example:

“https://example.com/service/v5.1/episodes/I5tY5jAcqHNTvRZR”

The above example may be used to perform a call to the specified URL. In response, the service computing device(s) 110 may send a response to the calling device (e.g., the electronic device 104). The response may include a JSON structure corresponding to the specified URL. For example, the JSON structure may include information about the audio. An example of a JSON structure including information for audio content is set forth below.

```
episodeinfo = {
  “createdOn”:1544144129000,
  “updatedOn”:1544144129000,
  “id”:1116,
  “uid”:“I5tY5jAcqHNTvRZR”,
  “userId”:“bb4deb21-962c-42ba-934c-4d772cae4736”,
  “networkId”:“nw_ChpNipzfWHc3B”,
  “public”:true,
  “name”:“The Food podcast: An interactive snippet”,
  “description”:“We've called in an expert to help you choose unique wines
that will impress your guests and hosts without busting your budget.”,
  “imageId”:“9aae2c88-9bf9-4ddc-9248-568169d4a131”,
  “publishTime”:1548288000000,
  “durationMillis”:113898,
  “transcriptId”:“b6882bb1-6749-43a7-af4f-60d8fa85127c”,
  “transSuggTaskId”:“ea032263-7dfe-4729-ae91-01fcc9df7672”,
  “trackInfoSuggTaskId”:“91b5f7a1-c063-4108-be40-d46ead489573”,
  “type”:“internal”,
  “date”:1544144129000,
  “status”:“FINISHED”,
  “trackSource”:“UPLOADED”,
  “urlSuffix”:“v1/1116-I5tY5jAcqHNTvRZR_.mp3”,
  “fpUrlSuffix”:“v1/1116.fp”,
  “fileSize”:1823554,
  “origFilePath”:“v1/1116”,
  “mimeType”:“audio/mpeg”,
  “creationTime”:1544144129000,
  “audioCollections”:[ ],
  “imageInfo”:{
    “id”:“9aae2c88-9bf9-4ddc-9248-568169d4a131”,
    “width”:2000,
    “height”:1120,
    “mimeType”:“image/jpeg”,
    “creationTime”:1548327327000,
    “createdOn”:1548327327000,
    “updatedOn”:1548327327000,
    “source”:null,
    “url”:“https://cdn.images.example.com/v1/9aae2c88-9bf9-4ddc-9248-
568169d4a131”,
    “thumbnailURL”:“https://cdn.images.example.com/v1/9aae2c88-9bf9-
4ddc-9248-568169d4a131.th”
  },
  “tagCount”:18,
  “audioUrl”:“https://static.example.com/audiotracks/v1/1116-
I5tY5jAcqHNTvRZR_.mp3”,
  “imageUrl”:“https://cdn.images.example.com/v1/9aae2c88-9bf9-4ddc-
9248-568169d4a131”,
  “thumbnail”:https://cdn.images.example.com/v1/9aae2c88-9bf9-4ddc-
9248-568169d4a131.th
}
```

Furthermore, the additional visual content may also be provided by using JSON structures. Below is an example of a JSON structure for providing a visual content tag to the client application 157 on the electronic device 104.

```
“TagDetails =”{
  “id”:”6a0ae3e0-43ef-4961-8099-559e1a4b716f”,
  “userId”:“bb4deb21-962c-42ba-934c-4d772cae4736”,
  “createdOn”:1547081332000,
  “actions”:“click”,
  “url”:“https://example.com/wraps/43ffad51-2b6b-441c-8dbd-f82415d22714”,
  “caption”:“Food Information: Presented by Media Pesenter”,
  “imageId”:“f028ce29-f403-4dfd-8b13-d1ea5b54f3d0”,
  “imageInfo”:{
    “id”:“f028ce29-f403-4dfd-8b13-d1ea5b54f3d0”,
    “width”:375,
    “height”:667,
    “mimeType”:“image/png”,
    “creationTime”:1547081332000,
    “createdOn”:1547081332000,
    “updatedOn”:1547081332000,
    “source”:null,
    “url”:“https://cdn.images.example.com/v1/f028ce29-f403-4dfd-8b13-
d1ea5b54f3d0”,
    “thumbnailURL”:“https://cdn.images.example.com/v1/f028ce29-f403-
4dfd-8b13-d1ea5b54f3d0”
  },
  “style”:{
    “fontStyle”:5,
    “imageOpacity”:0,
    “topMarginPercentage”:0.75
  },
  “saveable”:true,
  “shareable”:true,
  “make”:“CREATED”,
  “suggestionId”:null
}
```

When the main audio content is received at the electronic device 104, the third-party content tag may be decoded along with any other embedded tags in the main audio content by the client application 157. In response to detecting the third-party content tag, the client application 157 may send an application programming interface (API) POST request to a link to a third party computing device as indicated in the third-party tag, such as the additional content computing device(s) 112 discussed above with respect to FIG. 1. As one example, the third-party computing device may return selected additional content based on the keywords. In some examples, the received additional content may include an additional link to the third-party computing device or to a fourth party computing device. The received additional content and the link may be displayed in the same manner as an image with an associated link that may be received from the service computing device 110. In some cases, the third-party computing device may track the response of the consumers 155 with respect to the additional content and the line, and may provide information regarding consumer interactions to the source computing device 102.

FIG. 8 is a flow diagram illustrating an example process 800 for selecting content to be encoded into main audio content according to some implementations. In some examples, the process 800 may be executed at least in part by the source computing device 102 executing the encoding program 126 or the like. For instance, the content enhancement for audio content herein enables audio content to be matched with keywords such as based on one or more machine-learning models and/or based on application of one or more rules. In addition, implementations may enable the creation of visual tags, such as educational information, entertainment, interactive banners for presenting information, and so forth, automatically such as by using keywords that may be generated by transcribing audio and matching those keywords to a remote database or other data structure of enhanced information. The enhanced content may be searched and if multiple matches are found, multiple matches may be prioritized based on various rules or other criteria. These criteria may include availability, geolocation and so forth. In some cases, the additional information may be served dynamically using various types of distribution techniques. Furthermore, some examples herein may automatically determine contextual and relevant enhanced visual information that to associate with the main audio content. In some examples, the enhanced information may include a timing indicator an audio layer with a visual display as described above.

At 802, the computing device may receive the main audio content from an audio source for processing. For example, the main audio content may be any type of audio content such as podcasts, music, songs, recorded programming, live programming, or the like. Additionally, in some examples, the audio content may be a multimedia file or the like that includes audio content.

At 804, the computing device may transcribe the main audio content to obtain a transcript of the main audio content. For example, the computing device may apply natural language processing and speech to text recognition for creating a transcript of the speech and detectable words present in the main audio content.

At 806, the computing device may spot keywords in the transcript. In some examples, the computing device may access a keyword library, such as the keyword library 305 discussed above, that may include a plurality of previously identified keywords (i.e., words and phrases previously determined to be of interest, such as based on human selection or other indicators) that may be of interest for use in locating additional content relevant to the main audio content. Additionally, in some examples, the keyword spotting may be based on metadata associated with the particular received main audio content or based on various other techniques as discussed above.

At 808, the computing device may determine one or more filtered keywords, such as based on the keywords spotted in the transcript in 806 above. In some examples, the keywords may be ranked for filtering out keywords of lower interests. For instance, the computing device may sort the keywords and corresponding additional information based on a history of all content tags created and/or deleted and/or discarded by a human user, and further based on a history of all tags corresponding to the main audio content. Furthermore, if any specific keywords and/or additional content have been provided with the particular main audio content or with a tag for the main audio content (e.g., as discussed above with respect to FIG. 7), those keywords/content may be selected.

At 810, the computing device may retrieve one or more interactive visuals from a third party additional content computing device. For example, the computing device may employ an API POST call 809 or an API GET call 811 to retrieve the interactive visuals from the third-party additional content computing devices. For instance, a POST API call may enable a body message to be transferred. This may include one or more contextual keywords that are extracted from the audio transcription at that particular point in the audio or which may be added by the user in the user interface 138. A simplified example of a POST API call for keywords “cold” and “beverage” may include the following:

POST/test/HTTP 1.1

Host: foo.example

key1=“cold”&key2=“beverage”

On the other hand, the GET API call may be used to retrieve the additional information in JSON format, as discussed above. For instance, this may take place when the call is made from the electronic device 104 of the consumer 155 (e.g., as in the examples discussed above with respect to FIGS. 4 and 6), but could also take place in an API call from the source computing device 102. In some examples, when the GET API call is sent from the electronic device 104, additional information about the electronic device 104 may be included in the GET API call, such as geolocation and the client device information, e.g., the type of device the consumer is using, or the like.

At 812, the computing device may determine an audio sequence for insertion into the main audio content such as discussed above with respect to FIGS. 5 and 6.

At 814, the computing device may determine content tag selections based on the keywords spotted in the transcript.

At 816, the computing device may determine third-party interactive visual content, such as based on the API POST call 809 and/or the API GET 811 call.

At 818, the computing device may generate an audio timeline to enable the additional content to be embedded or otherwise associated with the main audio content.

At 820, the computing device may embed a timing indicator in the main audio content for determining a playback location of the audio sequence and any associated visual content.

At 822, the computing device may embed the interactive visual content or a link to the interactive visual content in the main audio content.

At 824, the computing device may embed a link to the third-party interactive visual content.

At 826, the computing device may send the enhanced audio content to the client application 157 on the electronic device 104.

The example processes described herein are only examples of processes provided for discussion purposes. Numerous other variations will be apparent to those of skill in the art in light of the disclosure herein. Further, while the disclosure herein sets forth several examples of suitable frameworks, architectures and environments for executing the processes, implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

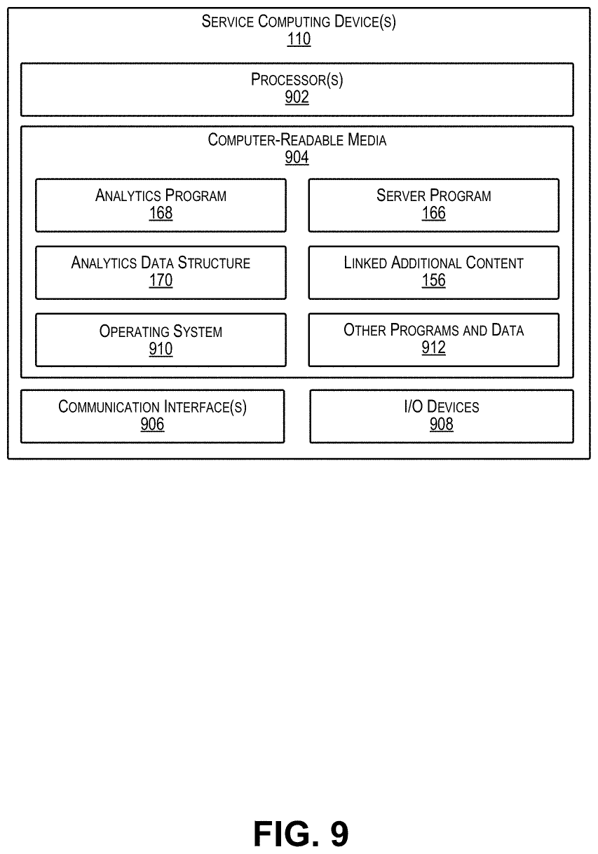

FIG. 9 illustrates select components of an example service computing device 110 that may be used to implement some functionality of the services described herein. The service computing device 110 may include one or more servers or other types of computing devices that may be embodied in any number of ways. For instance, in the case of a server, the programs, other functional components, and data may be implemented on a single server, a cluster of servers, a server farm or data center, a cloud-hosted computing service, and so forth, although other computer architectures may additionally or alternatively be used.

Further, while the figures illustrate the components and data of the service computing device 110 as being present in a single location, these components and data may alternatively be distributed across different computing devices and different locations in any manner. Consequently, the functions may be implemented by one or more service computing devices, with the various functionality described above distributed in various ways across the different computing devices. Multiple service computing devices 110 may be located together or separately, and organized, for example, as virtual servers, server banks, and/or server farms. The described functionality may be provided by the servers of a single entity or enterprise, or may be provided by the servers and/or services of multiple different entities or enterprises.

In the illustrated example, each service computing device 110 may include one or more processors 902, one or more computer-readable media 904, and one or more communication interfaces 906. Each processor 902 may be a single processing unit or a number of processing units, and may include single or multiple computing units, or multiple processing cores. The processor(s) 902 can be implemented as one or more microprocessors, microcomputers, microcontrollers, digital signal processors, central processing units, state machines, logic circuitries, and/or any devices that manipulate signals based on operational instructions. For instance, the processor(s) 902 may be one or more hardware processors and/or logic circuits of any suitable type specifically programmed or configured to execute the algorithms and processes described herein. The processor(s) 902 can be configured to fetch and execute computer-readable instructions stored in the computer-readable media 904, which can program the processor(s) 902 to perform the functions described herein.

The computer-readable media 904 may include volatile and nonvolatile memory and/or removable and non-removable media implemented in any type of technology for storage of information, such as computer-readable instructions, data structures, program modules, or other data. Such computer-readable media 904 may include, but is not limited to, RAM, ROM, EEPROM, flash memory or other memory technology, optical storage, solid state storage, magnetic tape, magnetic disk storage, storage arrays, network attached storage, storage area networks, cloud storage, or any other medium that can be used to store the desired information and that can be accessed by a computing device. Depending on the configuration of the service computing device 110, the computer-readable media 904 may be a tangible non-transitory media to the extent that, when mentioned, non-transitory computer-readable media exclude media such as energy, carrier signals, electromagnetic waves, and signals per se.

The computer-readable media 904 may be used to store any number of functional components that are executable by the processor(s) 902. In many implementations, these functional components comprise instructions or programs that are executable by the processor(s) 902 and that, when executed, specifically configure the one or more processors 902 to perform the actions attributed above to the service computing device 110. Functional components stored in the computer-readable media 904 may include the server program 166 and the analytics program 168. Additional functional components stored in the computer-readable media 904 may include an operating system 910 for controlling and managing various functions of the service computing device 110.

In addition, the computer-readable media 904 may store data and data structures used for performing the operations described herein. Thus, the computer-readable media 904 may store the linked additional content 156 that is served to the electronic devices of audience members, as well as the analytics data structure 170. The service computing device 110 may also include or maintain other functional components and data not specifically shown in FIG. 9, such as other programs and data 912, which may include programs, drivers, etc., and the data used or generated by the functional components. Further, the service computing device 110 may include many other logical, programmatic, and physical components, of which those described above are merely examples that are related to the discussion herein.

The communication interface(s) 906 may include one or more interfaces and hardware components for enabling communication with various other devices, such as over the network(s) 106. For example, communication interface(s) 906 may enable communication through one or more of the Internet, cable networks, cellular networks, wireless networks (e.g., Wi-Fi) and wired networks (e.g., fiber optic and Ethernet), as well as short-range communications, such as BLUETOOTH®, BLUETOOTH® low energy, and the like, as additionally enumerated elsewhere herein.

The service computing device 110 may further be equipped with various input/output (I/O) devices 908. Such I/O devices 908 may include a display, various user interface controls (e.g., buttons, joystick, keyboard, mouse, touch screen, etc.), audio speakers, connection ports and so forth.

In addition, the other computing devices described above, such as the one or more additional content computing devices 112 may have a similar hardware configuration to that described above with respect to the service computing devices 110, but with different data and functional components executable for performing the functions described for each of these devices.

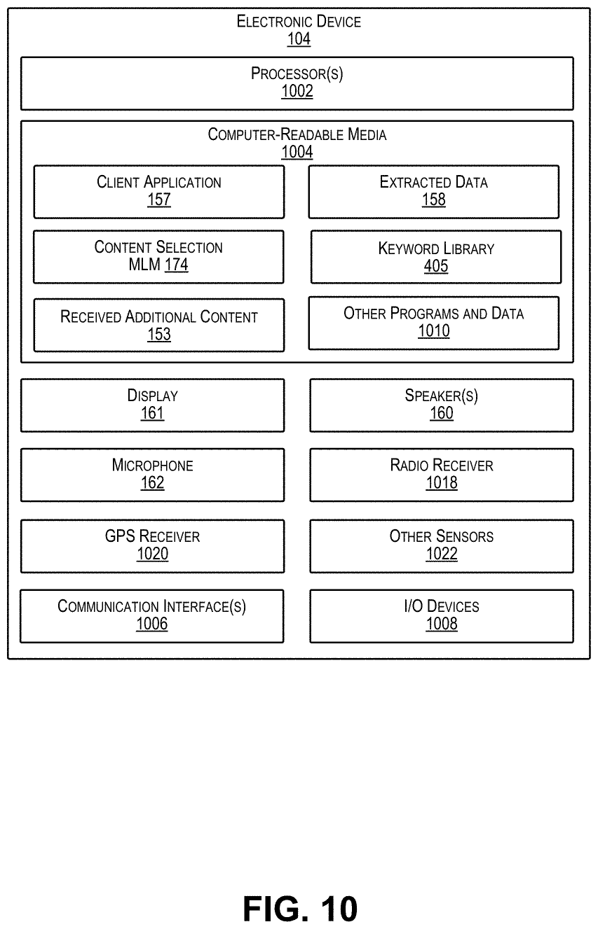

FIG. 10 illustrates select example components of an electronic device 104 according to some implementations. The electronic device 104 may be any of a number of different types of computing devices, such as mobile, semi-mobile, semi-stationary, or stationary. Some examples of the electronic device 104 may include tablet computing devices, smart phones, wearable computing devices or body-mounted computing devices, and other types of mobile devices; laptops, netbooks and other portable computers or semi-portable computers; desktop computing devices, terminal computing devices and other semi-stationary or stationary computing devices; augmented reality devices and home audio systems; vehicle audio systems, voice activated home assistant devices, or any of various other computing devices capable of storing data, sending communications, and performing the functions according to the techniques described herein.

In the example of FIG. 10, the electronic device 104 includes a plurality of components, such as at least one processor 1002, one or more computer-readable media 1004, one or more communication interfaces 1006, and one or more input/output (I/O) devices 1008. Each processor 1002 may itself comprise one or more processors or processing cores. For example, the processor 1002 can be implemented as one or more microprocessors, microcomputers, microcontrollers, digital signal processors, central processing units, state machines, logic circuitries, and/or any devices that manipulate signals based on operational instructions. In some cases, the processor 1002 may be one or more hardware processors and/or logic circuits of any suitable type specifically programmed or otherwise configured to execute the algorithms and processes described herein. The processor 1002 can be configured to fetch and execute computer-readable processor-executable instructions stored in the computer-readable media 1004.

Depending on the configuration of the electronic device 104, the computer-readable media 1004 may be an example of tangible non-transitory computer storage media and may include volatile and nonvolatile memory and/or removable and non-removable media implemented in any type of technology for storage of information such as computer-readable instructions, data structures, program modules, or other data. The computer-readable media 1004 may include, but is not limited to, RAM, ROM, EEPROM, flash memory, solid-state storage, magnetic disk storage, optical storage, and/or other computer-readable media technology. Further, in some cases, the electronic device 104 may access external storage, such as storage arrays, network attached storage, storage area networks, cloud storage, or any other medium that can be used to store information and that can be accessed by the processor 1002 directly or through another computing device or network. Accordingly, the computer-readable media 1004 may be computer storage media able to store instructions, modules, or components that may be executed by the processor 1002. Further, when mentioned, non-transitory computer-readable media exclude media such as energy, carrier signals, electromagnetic waves, and signals per se.

The computer-readable media 1004 may be used to store and maintain any number of functional components that are executable by the processor 1002. In some implementations, these functional components comprise instructions or programs that are executable by the processor 1002 and that, when executed, implement algorithms or other operational logic for performing the actions attributed above to the electronic devices herein. Functional components of the electronic device 104 stored in the computer-readable media 1004 may include the client application 157, as discussed above, that may be executed for extracting embedded data from received audio content.

The computer-readable media 1004 may also store data, data structures and the like, that are used by the functional components. Examples of data stored by the electronic device 104 may include the extracted data 158, the received additional content 153 and the keyword library 405. In addition, in some examples, computer-readable media 1004 may store the content selection machine-learning model 174. Depending on the type of the electronic device 104, the computer-readable media 1004 may also store other functional components and data, such as other programs and data 1010, which may include an operating system for controlling and managing various functions of the electronic device 104 and for enabling basic user interactions with the electronic device 104, as well as various other applications, modules, drivers, etc., and other data used or generated by these components. Further, the electronic device 104 may include many other logical, programmatic, and physical components, of which those described are merely examples that are related to the discussion herein.

The communication interface(s) 1006 may include one or more interfaces and hardware components for enabling communication with various other devices, such as over the network(s) 106 or directly. For example, communication interface(s) 1006 may enable communication through one or more of the Internet, cable networks, cellular networks, wireless networks (e.g., Wi-Fi) and wired networks, as well as close-range communications such as BLUETOOTH®, and the like, as additionally enumerated elsewhere herein.

FIG. 10 further illustrates that the electronic device 104 may include the display 161. Depending on the type of computing device used as the electronic device 104, the display 136 may employ any suitable display technology.

The electronic device 104 may further include one or more speakers 160, a microphone 162, a radio receiver 1018, a GPS receiver 1020, and one or more other sensors 1022, such as an accelerometer, gyroscope, compass, proximity sensor, and the like. The electronic device 104 may further include the one or more I/O devices 1008. The I/O devices 1008 may include a camera and various user controls (e.g., buttons, a joystick, a keyboard, a keypad, touchscreen, etc.), a haptic output device, and so forth. Additionally, the electronic device 104 may include various other components that are not shown, examples of which may include removable storage, a power source, such as a battery and power control unit, and so forth.

Various instructions, methods, and techniques described herein may be considered in the general context of computer-executable instructions, such as computer programs and applications stored on computer-readable media, and executed by the processor(s) herein. Generally, the terms program and application may be used interchangeably, and may include instructions, routines, modules, objects, components, data structures, executable code, etc., for performing particular tasks or implementing particular data types. These programs, applications, and the like, may be executed as native code or may be downloaded and executed, such as in a virtual machine or other just-in-time compilation execution environment. Typically, the functionality of the programs and applications may be combined or distributed as desired in various implementations. An implementation of these programs, applications, and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A system comprising:
an audio encoder for embedding data into audio content; and
a first computing device in communication with the audio encoder, the first computing device including one or more processors configured by executable instructions to perform operations comprising:
presenting, by the one or more processors, in a user interface, text of a transcript of the audio content, the user interface further including a timeline representative of at least a portion of the audio content;
identifying, by the one or more processors, a plurality of keywords in the text;
determining, by the one or more processors, based on a first keyword of the plurality of keywords, first data to associate with a time in the timeline in the user interface; and
sending, by the one or more processors, to the audio encoder, the first data to cause the audio encoder to embed the first data in the audio content at a timing corresponding to the time in the timeline to generate enhanced audio content.

2. The system as recited in claim 1, the operations further comprising sending the enhanced audio content to at least one electronic device as at least one of:
streaming content sent over a network, or
broadcasted content sent as a radio wave.

3. The system as recited in claim 1, the operation of determining, based on at least one of the keywords, the first data to associate with the time in the timeline further comprising inputting the keyword into a machine-learning model to determine, at least in part, the first data to associate with the time in the timeline.

4. The system as recited in claim 3, the operations further comprising:
selecting, based on a second keyword, second data to associate with a different time in the timeline;
receiving a user input to change at least one of the second data or the different time in the timeline; and
updating the machine-learning model based at least in part on the user input.

5. The system as recited in claim 3, the operations further comprising:
receiving feedback regarding consumer interactions with the first data on a plurality of electronic devices; and
updating the machine-learning model based at least in part on receiving the feedback.

6. The system as recited in claim 1, the operations further comprising sending second data to a second computing device to be provided for download to a plurality of electronic devices, wherein the first data embedded in the audio content includes information for identifying the first data following extraction of the embedded data by an electronic device of the plurality of electronic devices.

7. The system as recited in claim 6, wherein:
the second data includes additional audio content and at least one visual content associated with the additional audio content,
the additional audio content being configured to be played back at an electronic device during playback of the audio content according to a timing corresponding to the time in the timeline.

8. A system comprising:
an audio encoder for embedding data into audio content; and
a first computing device in communication with the audio encoder, the first computing device including one or more processors configured by executable instructions to perform operations comprising:
receiving audio content;
generating a transcript of the audio content;
determining a plurality of keywords in the transcript;
determining, based on at least one of the keywords, first content to associate with the audio content; and
sending, to the encoder, the first content to cause the audio encoder to embed the first content in the audio content at a timing corresponding at least in part to the transcript to generate enhanced audio content.

9. The system as recited in claim 8, the operations further comprising sending the enhanced audio content to an electronic device to cause, at least in part, an application executing on the electronic device to present information related to the first content during presentation of the enhanced audio content.

10. The system as recited in claim 8, the operation of determining, based on at least one of the keywords, the first content to associate with the audio content further comprising inputting the at least one keyword into a machine-learning model to determine, at least in part, the first data to associate with the time in the timeline.

11. The system as recited in claim 10, the operations further comprising:
selecting, based on a second keyword, second data to associate with a different time in the timeline;
receiving a user input to change at least one of the second data or the different time in the timeline; and
updating the machine-learning model based at least in part on the user input.

12. The system as recited in claim 8, the operation of determining the plurality of keywords in the transcript further comprising referring to at least one of a keyword data structure or metadata associated with the audio content.

13. The system as recited in claim 8, the operations further comprising sending second data to a second computing device to be provided for download to a plurality of electronic devices, wherein the first data embedded in the audio content includes information for identifying the first data following extraction of the embedded data by an electronic device of the plurality of electronic devices.

14. The system as recited in claim 8, the operations further comprising ranking the plurality of keywords based at least in part on a history of user interaction with data previously embedded in audio content.

15. An electronic device comprising:
a display;
a processor coupled to the display, the processor configured by executable instructions to perform operations comprising:
receiving audio content at the electronic device;
transcribing at least a portion of the audio content to generate text of a transcript of the audio content;
identifying, by the one or more processors, a plurality of keywords in the text;
determining, based on at least one of the keywords, at least one additional content to present during presentation of the audio content on the electronic device; and
presenting the at least one additional content on the display during presentation of the audio content on the electronic device.

16. The electronic device as recited in claim 15, the operations further comprising using a machine-learning model to select, at least in part, the at least one additional content based on the at least one keyword.

17. The electronic device as recited in claim 16, the operations further comprising receiving the machine-learning model with an application configured to extract embedded data from the audio content.

18. The electronic device as recited in claim 15, the operation of identifying, by the one or more processors, a plurality of keywords in the text further comprising referring to a keyword library stored on the electronic device to determine the plurality of keywords.

19. The electronic device as recited in claim 15, the operations further comprising:
sending one or more of the keywords to a computing device over a network; and
receiving, over the network, as the additional content, visual interactive content.

20. The electronic device as recited in claim 15, wherein the second data includes additional audio content and at least one visual content associated with the additional audio content, the operations further comprising:
during presentation of the audio content, ceasing presentation of the audio content, and presenting the additional audio content and associated at least one visual content while the audio content is ceased.
